(19) United States
(12) Patent Application Publication
(10) Pub. No.: US 2026/0101285 A1
(43) Pub. Date: Apr. 9, 2026

(54) Network Energy Saving Management

(71) Applicant: Ofinno, LLC, Reston, VA (US)

(72) Inventors: Jinsook Ryu, Oakton, VA (US); SungDuck Chun, Fairfax, VA (US); Esmael Hejazi Dinan, McLean, VA (US); Kyungmin Park, Vienna, VA (US); Jian Xu, McLean, VA (US); Taehun Kim, Fairfax, VA (US); Sivapathalingham Sivavakeesar, Reston, VA (US); Hua Zhou, Vienna, VA (US)

(21) Appl. No.: 19/350,945

(22) Filed: Oct. 6, 2025

Related U.S. Application Data
(60) Provisional application No. 63/704,873, filed on Oct. 8, 2024.

(51) Int. Cl. H04W 52/02

(52) U.S. Cl. CPC H04W 52/0235

(57) ABSTRACT

A distributed unit (DU) receives from a central unit (CU), one or more messages comprising one or more parameters indicating that network energy saving (NES) is authorized for a wireless device.

### CROSS-REFERENCE TO RELATED APPLICATIONS

This application claims the benefit of U.S. Provisional Application No. 63/704,873, filed Oct. 8, 2024, which is hereby incorporated by reference in its entirety.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 is an example diagram of an aspect of an embodiment of the present disclosure.

FIG. 18 is an example diagram of an aspect of an embodiment of the present disclosure.

FIG. 19 is an example diagram of an aspect of an embodiment of the present disclosure.

FIG. 20 is an example diagram of an aspect of an embodiment of the present disclosure.

FIG. 21 is an example diagram of an aspect of an embodiment of the present disclosure.

FIG. 22 is an example diagram of an aspect of an embodiment of the present disclosure.

FIG. 23 is an example diagram of an aspect of an embodiment of the present disclosure.

FIG. 24 is an example diagram of an aspect of an embodiment of the present disclosure.

FIG. 25 is an example diagram of an aspect of an embodiment of the present disclosure.

FIG. 26A, FIG. 26B and FIG. 26C is an example diagram of an aspect of an embodiment of the present disclosure.

FIG. 27 is an example diagram of an aspect of an embodiment of the present disclosure.

FIG. 28 is an example diagram of an aspect of an embodiment of the present disclosure.

FIG. 29 is an example diagram of an aspect of an embodiment of the present disclosure.

FIG. 30 is an example diagram of an aspect of an embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that affect or implement the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, MATLAB or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

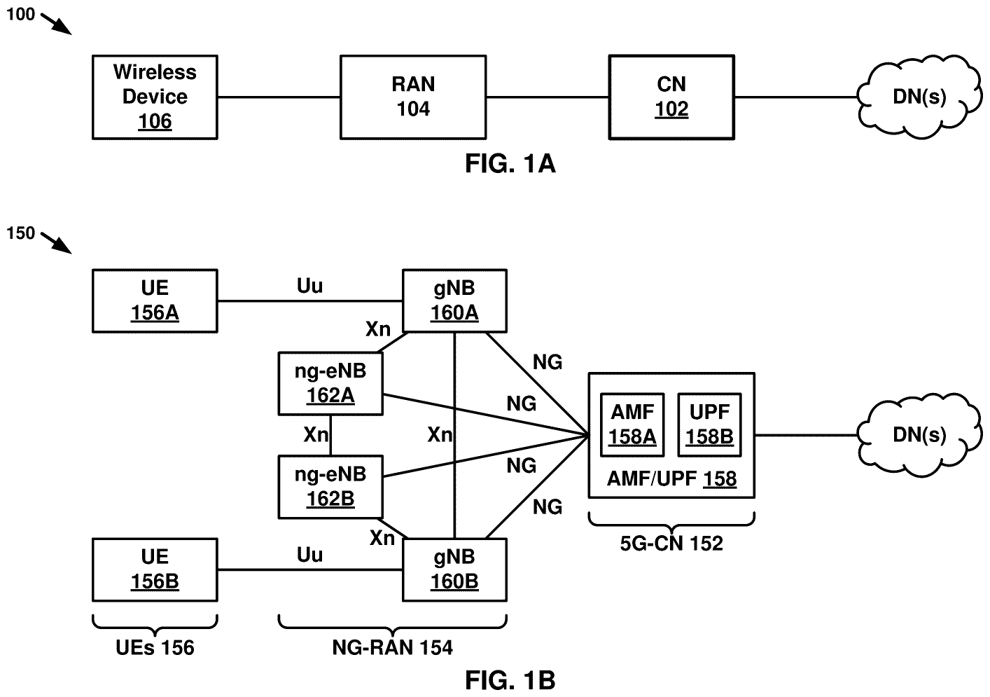

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNs (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, Wi-Fi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNs (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

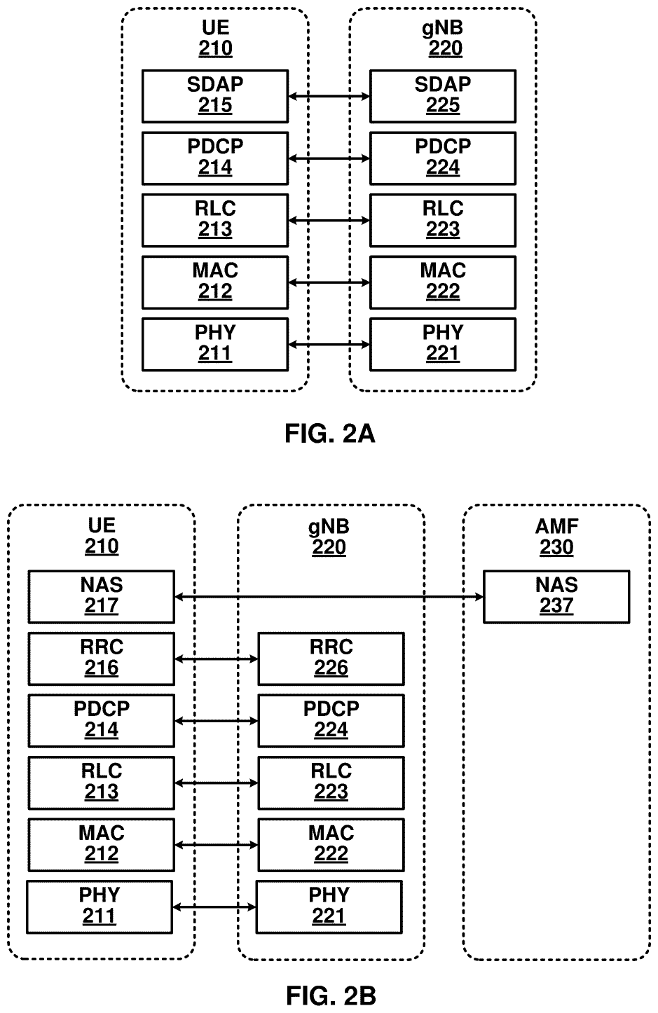

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

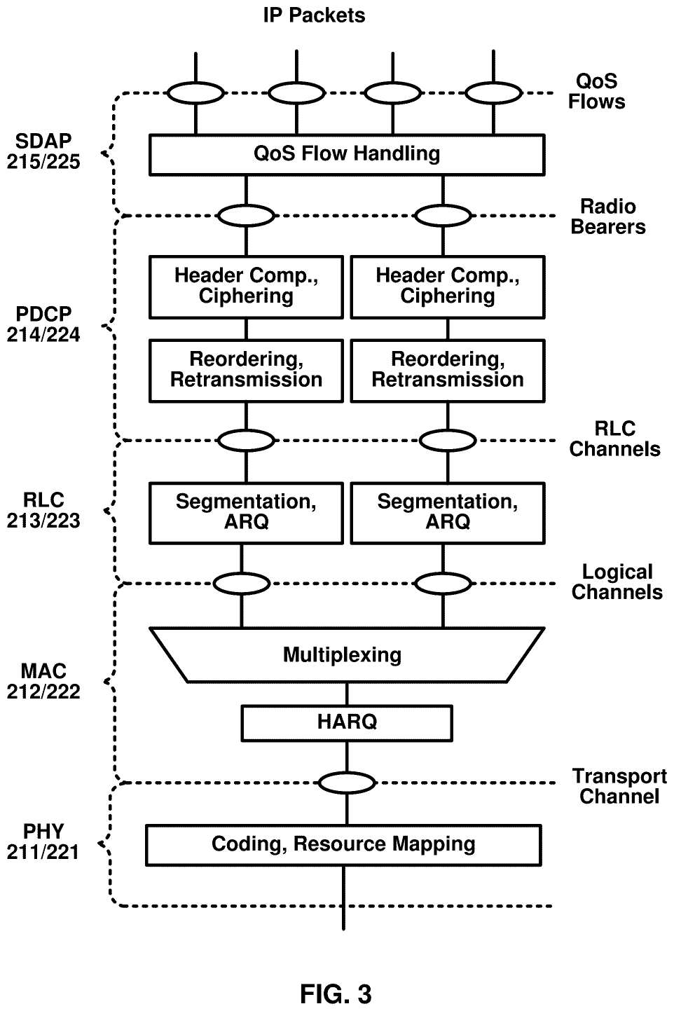

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

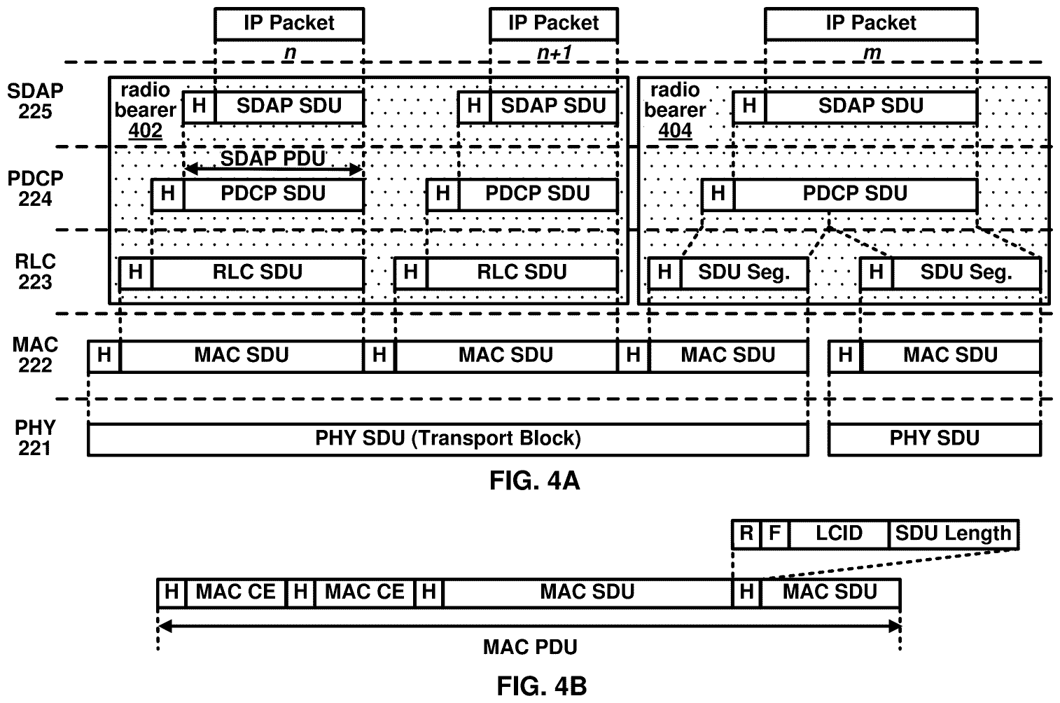

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

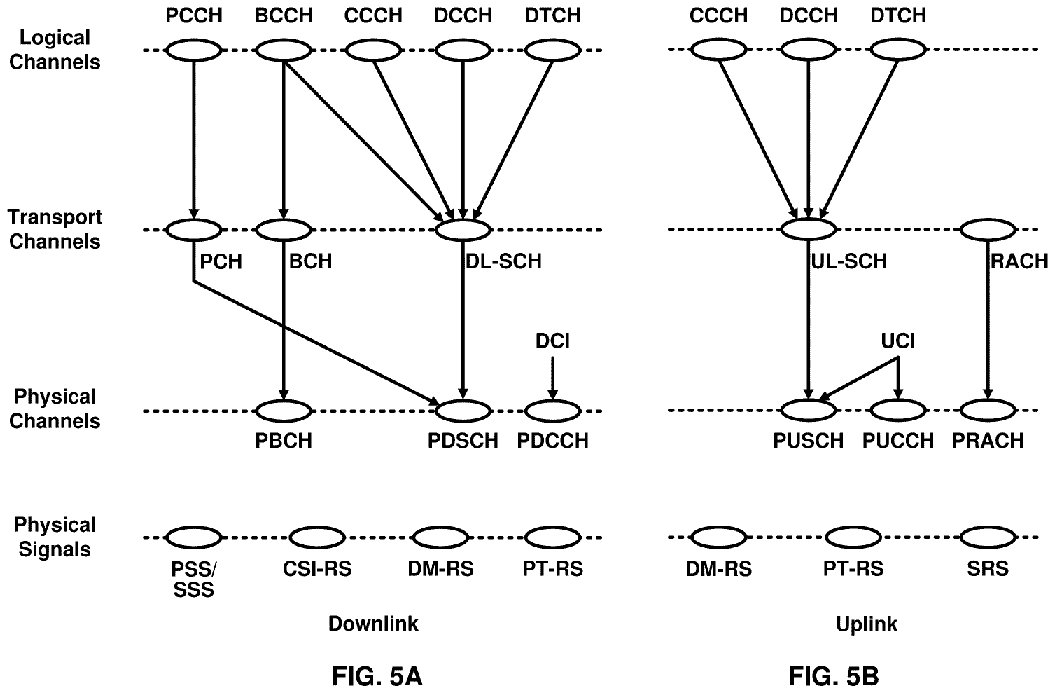

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

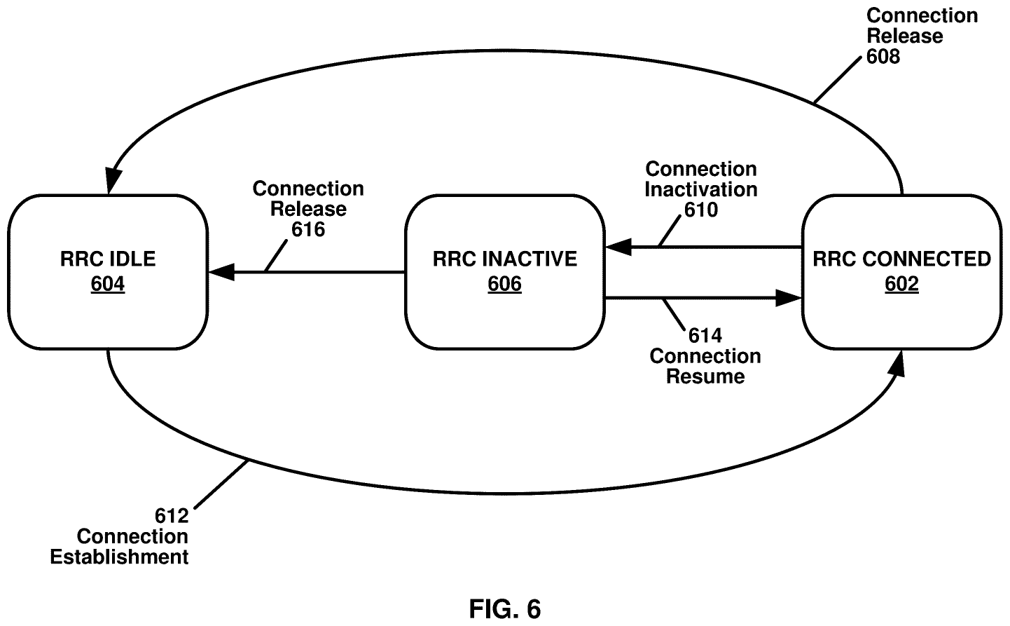

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split into two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

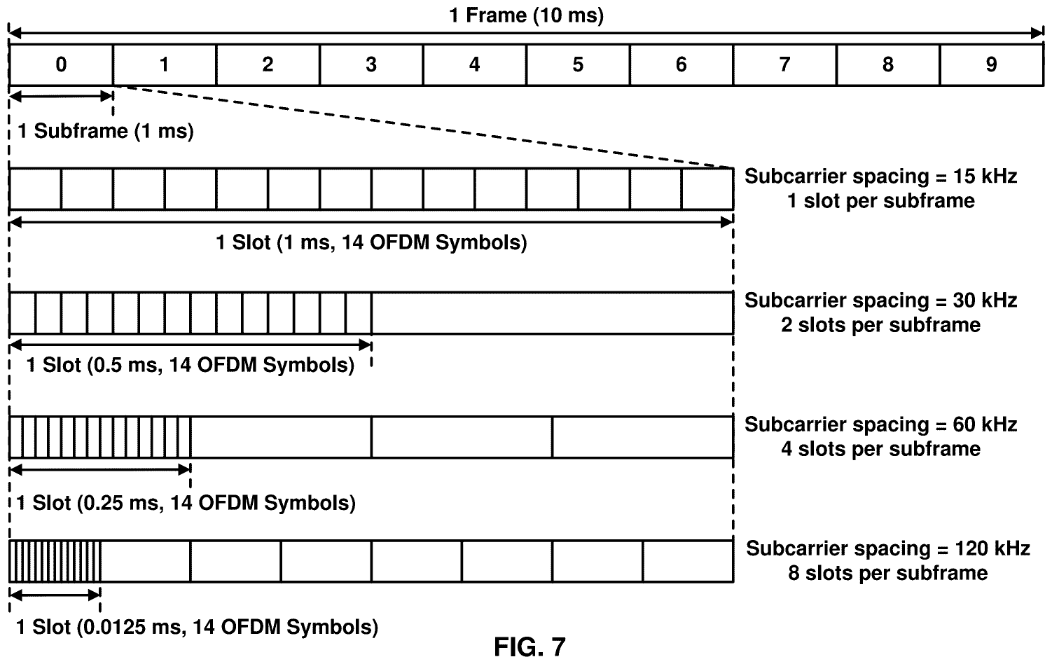

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 kHz/2.3 μs; 60 kHz/1.2 μs; 120 kHz/0.59 μs; and 240 kHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

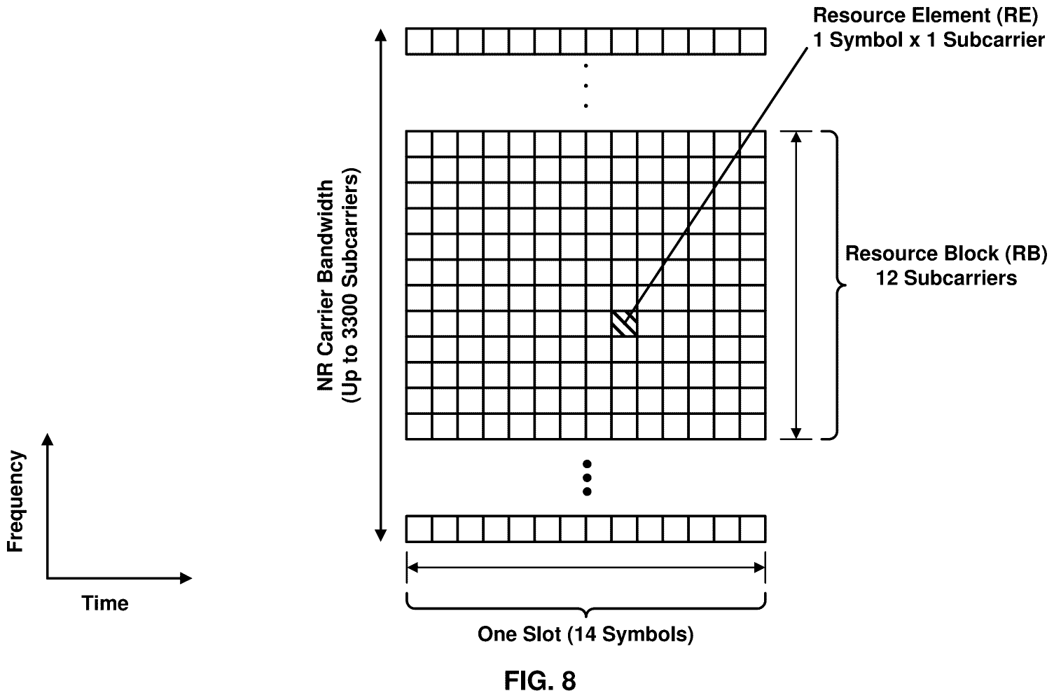

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

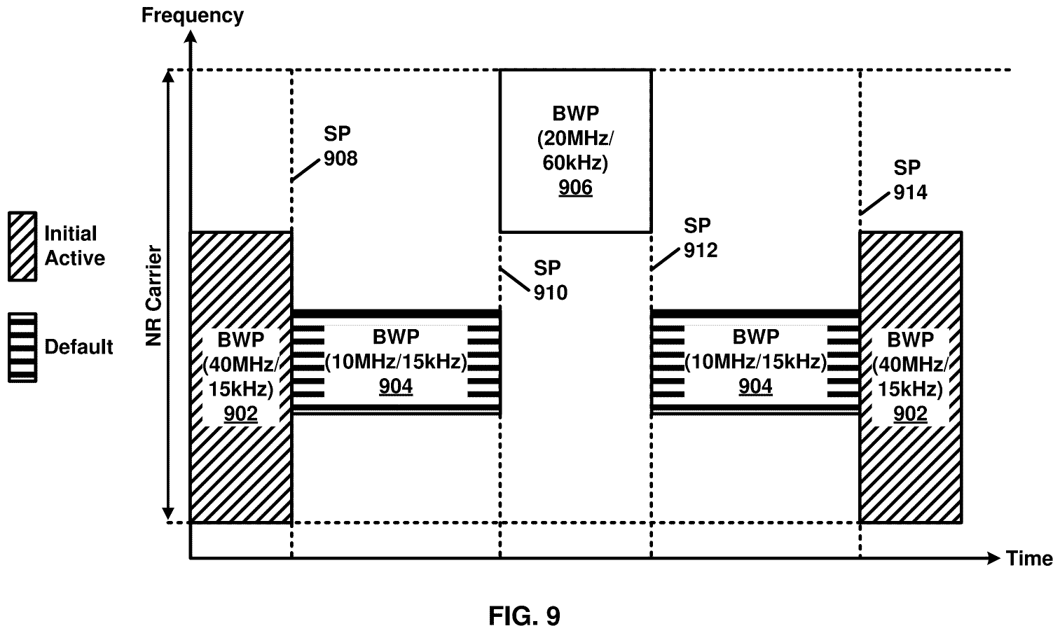

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 kHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response to receiving a DCI indicating BWP 906 as the active BWP. The UE may switch at a switching point 912 from active BWP 906 to BWP 904 in response to an expiry of a BWP inactivity timer and/or in response to receiving a DCI indicating BWP 904 as the active BWP. The UE may switch at a switching point 914 from active BWP 904 to BWP 902 in response to receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

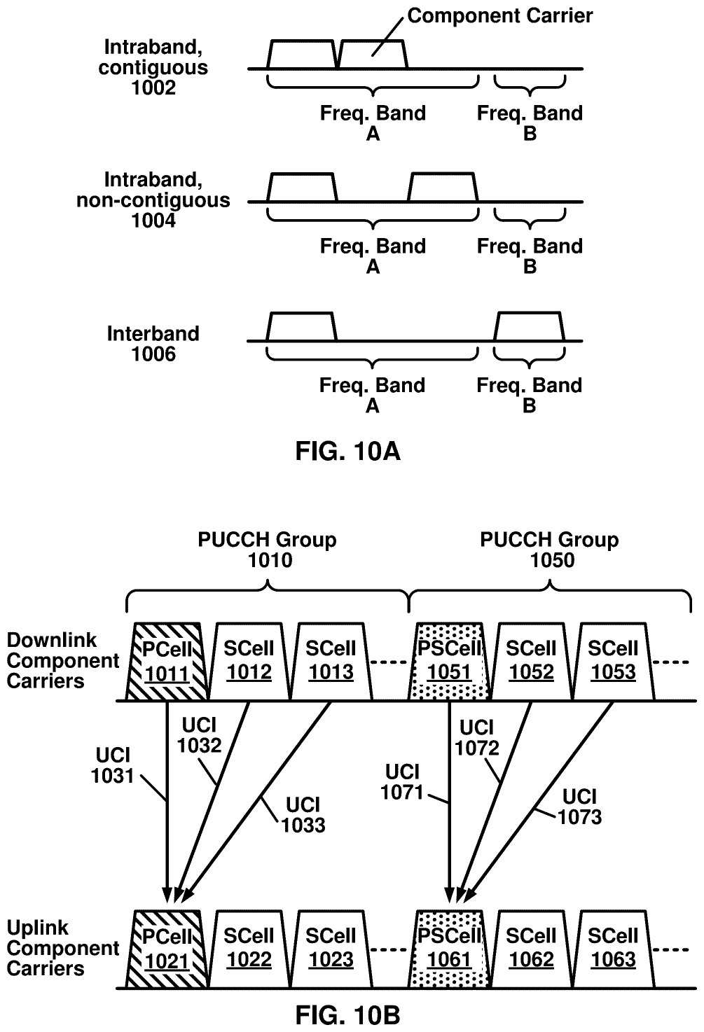

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1810 and a PUCCH group 1850 may include one or more downlink CCs, respectively. In the example of FIG. 10B, the PUCCH group 1810 includes three downlink CCs: a PCell 1011, an SCell 1012, and an SCell 1013. The PUCCH group 1850 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary SCell (PSCell) 1061, an SCell 1062, and an SCell 1063. Uplink control information (UCI) related to the downlink CCs of the PUCCH group 1810, shown as UCI 1031, UCI 1032, and UCI 1033, may be transmitted in the uplink of the PCell 1021. Uplink control information (UCI) related to the downlink CCs of the PUCCH group 1850, shown as UCI 1071, UCI 1072, and UCI 1073, may be transmitted in the uplink of the PSCell 1061. In an example, if the aggregated cells depicted in FIG. 10B were not divided into the PUCCH group 1810 and the PUCCH group 1850, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

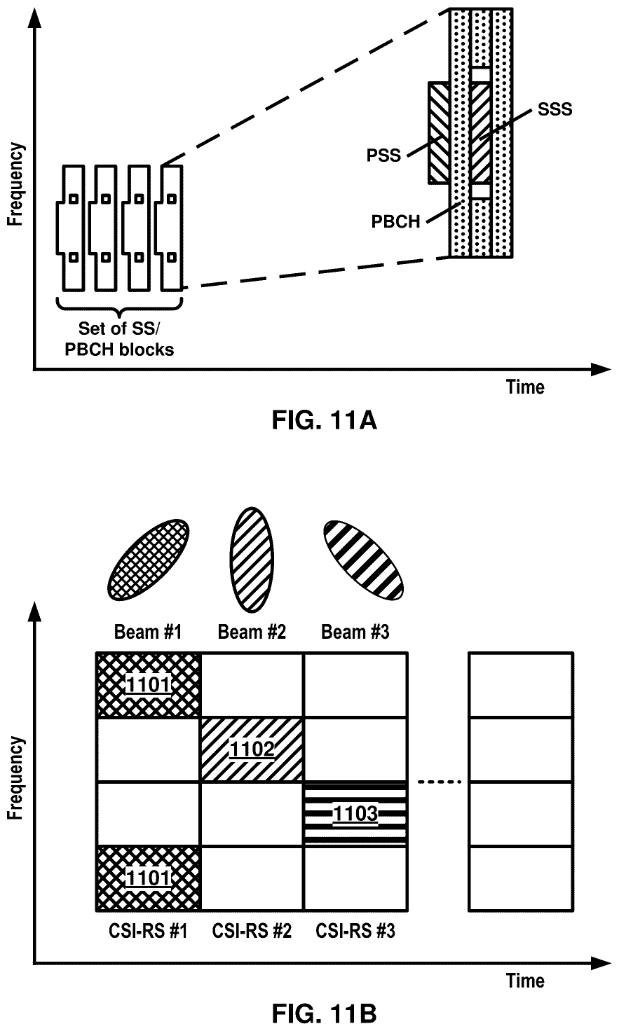

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g., a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g., maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM)) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in an SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

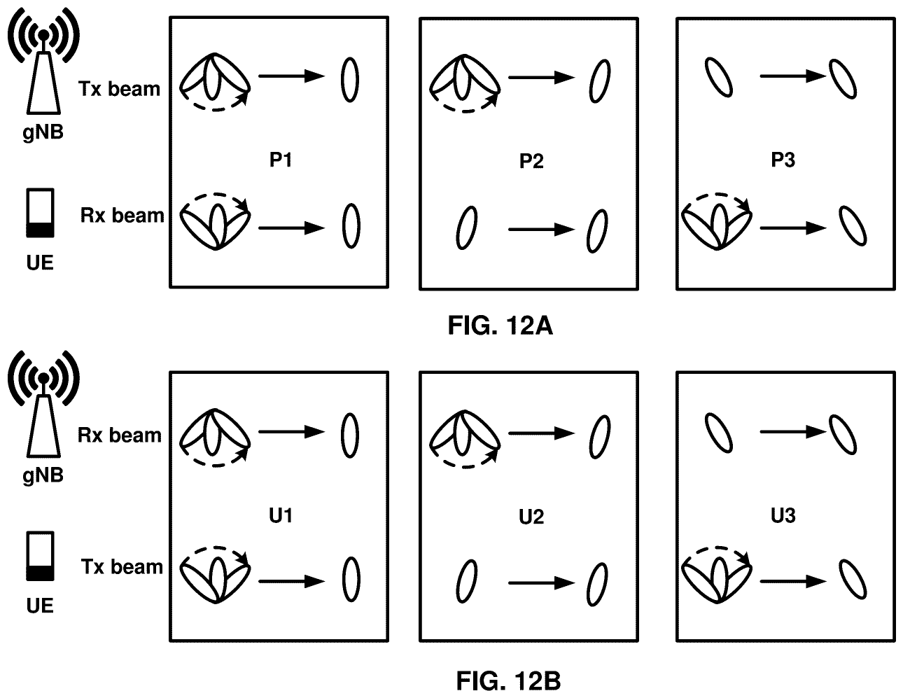

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counterclockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counterclockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counterclockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

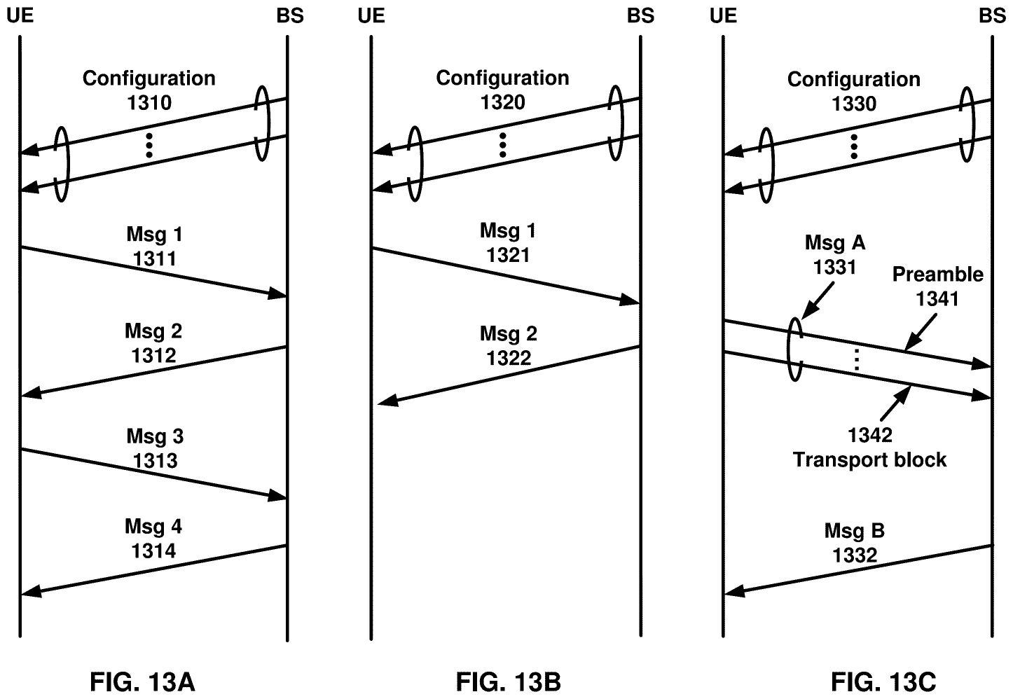

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preambleTransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id, where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI)). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

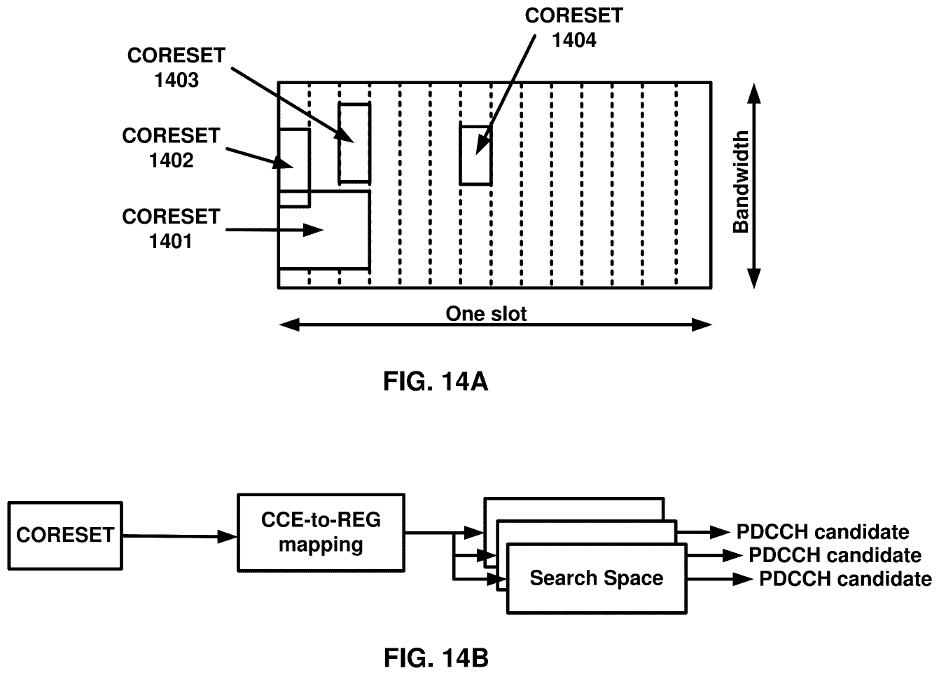

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g., a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

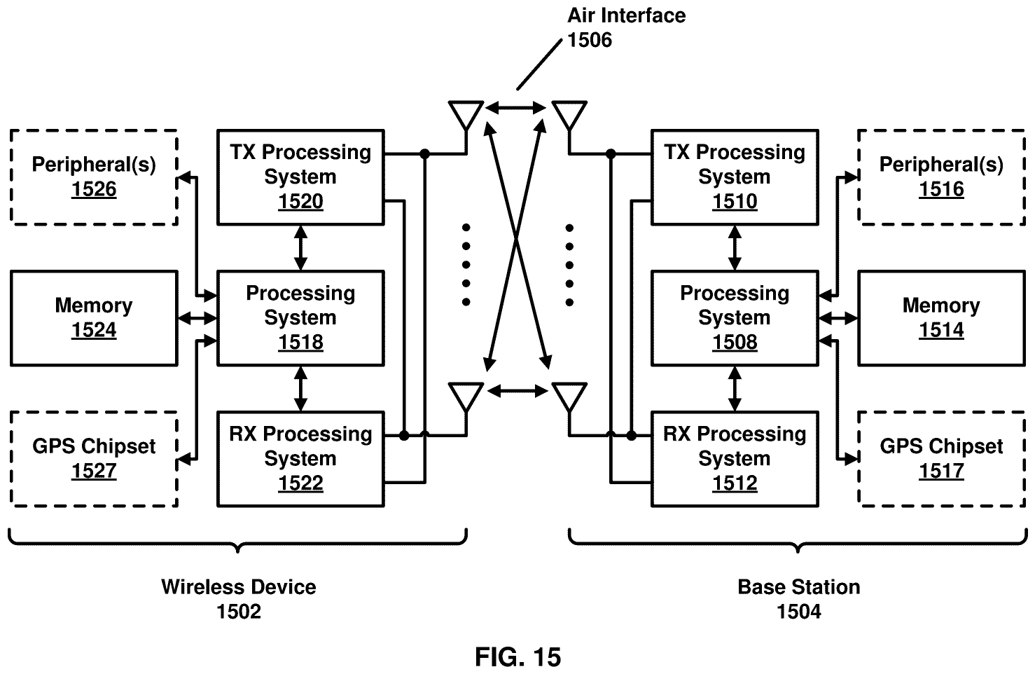

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

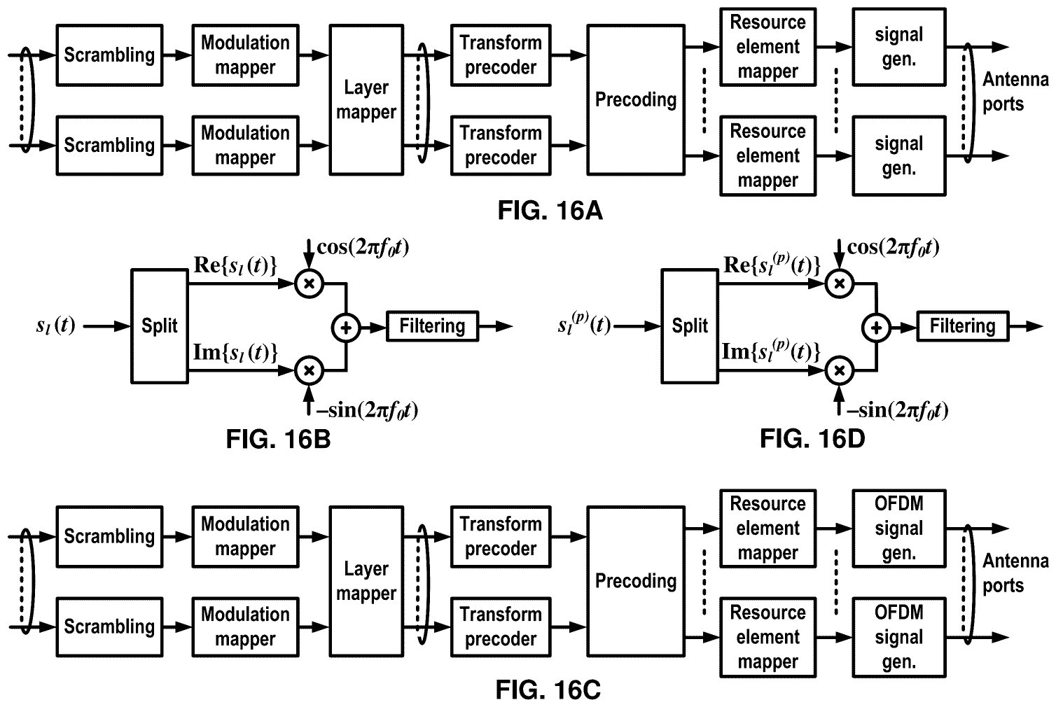

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, a CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g., RRC messages) comprising configuration parameters of a plurality of cells (e.g., primary cell, secondary cell). The wireless device may communicate with at least one base station (e.g., two or more base stations in dual connectivity) via the plurality of cells. The one or more messages (e.g., as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g., the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry (or expiration) of a random access response window timer, the time difference between two time stamps may be used. When a timer is restarted, a process for measurement of time window may be restarted. Other example implementations may be provided to restart a measurement of a time window.

In an example implementation of AI/ML model-based management of a radio channel, to have confidence in a data driven CSI reporting mechanism may require model monitoring in live networks. For the CSI compression use case, such monitoring may imply a comparison between the input and the output of the autoencoder based neural network (that is from the encoder input to the decoder output). Different from the single side AI/ML use cases, the input and output may reside on different sides of the Uu interface and are in the typical case owned by different vendors.

AI/ML model-based management of a radio channel (e.g., compressed CSI report, CSI prediction, etc.) may be necessary for the network to be able to perform monitoring of the encoder-decoder model performance. Such target CSI may have higher resolution and thus UCI payload than a “normal” compressed CSI report, but on the other hand the latency requirements are significantly relaxed in comparison.

The target CSI reported from UE to the gNB in live networks together with the “normal” AI/ML based CSI report from the UE may also be used for decoder fine tuning, i.e., using offline training of an improved decoder model without the need to update already deployed encoder models in the networks. Fine tuning, which may be based on real data collected in the field using real deployed UEs and gNBs, may be able to compensate from losses due to any idealities not captured in the dataset used in the initial training before the deployment.

For CSI compression use case, it may be required procedures and associated data format for UE to gNB data collection of a high-resolution CSI (target CSI) to enable model monitoring and to provide data for enabling decoder fine tuning.

The cellular network may be “one to many” in its characteristics, where one gNB serves multiple UEs simultaneously. For the CSI reporting use case, the gNB may need to process multiple CSI reports in parallel and to keep implementation efficiency, cost, and complexity feasible, it may be beneficial that one and the same decoder may be used for all UEs that is served by the gNB. Having a single encoder in the UE may be less important since such switching of encoders happens very rarely, maybe only in roaming situations.

For CSI compression use case, it may be required that training types and methods that enables a single decoder to be implemented in the network side may be considered.

A network may train a decoder-encoder first, transfer the latent space or gradient to the UE side and discard its nominal encoder or alternatively, and/or deliver the trained encoder to the UE side.

It may be assumed that training between UE chipset and NW vendors may be carried out offline. This may produce an encoder and decoder for deployment in products. The UE may be implemented in multiple different UE vendor's products, with different RF and antenna characteristics. The offline trained encoder and decoder may not perform as well in reality as in the training phase.

In addition, the training data used for this offline training may need to come from a variety of deployment scenarios and UE/chipset vendors to ensure good generalization performance. Such data may be gathered for the pre-development and offline training and there may be a mechanism to support improvements of the AI-CSI to make it possible to enable AI-CSI for new scenarios (e.g., tunnels, railways, stadiums).

It may be possible to have the possibility to fine tune the model based on actual data measured in the field, using measurements by deployed UEs. The fine tuning may be carried out by the decoder, since changing the encoder behavior in the field leads to a bifurcation in the number of model variants in the field which leads to a significant complexity increase in the network, for the monitoring of UE side models.

In addition, the single gNB decoder development may be exposed to a training data set from all kinds of deployment scenarios, UE chipsets from multiple chipset vendors, UE RF implementations and UE antennas from multiple UE vendors, but also a large variety of gNB antennas and RF, baseband implementations from different sites of multiple networks. Data to train the decoder for the two-sided case may be collected “in the field” and from many participating UE side vendors and implementations.

A data collection may support decoder fine tuning operations and retraining on the network side. This may allow to take full advantage of AI/ML potential, a trained decoder in the gNB could be further adapted to the local deployment (local radio propagation characteristics or local antenna configuration) to enhance the performance or to reduce the CSI payload.

For example, in a FWA deployment or in a deployment with primarily LOS channel, the channel characteristics may be very different compared to a dense urban with high rise buildings. Using local adaptation of the decoder for these scenarios may be beneficial. Allowing for some degree of site or area optimization (local adaptation) may provide the opportunity to use smaller AI/ML models and better performance since the need for the model to be able generalize to all scenarios is less.

A model update may be need in the deployed UE, where a new model may be delivered to the UE using e.g., firmware update over the air (FOTA). Alternatively, a model switch to a new model may be needed when the UE is roaming and a different network vendor may be used in the new serving network, and hence a different decoder. The UE may thus need to store (at least) one encoder for each network vendor decoder, but the switching between encoder models may happen rarely in the UE. The Model ID and/or UE capability may be a method to align the encoder-decoder model pair in the network.

A target CSI may be defined for several procedures in the specifications. During inference, the gNB may need to be able to interpret the decoder output so it can further use it for scheduling and MIMO precoding algorithms. In data collection, the target CSI may define the metric that the UE needs to measure and report to the network. There may be a need to use target CSI for model monitoring purpose as the NW can compare reported “real” CSI with the target CSI.

A beam-delay processing of precoding vector feedback may have advantages. For example, the model-based approach may have a lower overhead than the corresponding “raw” feedback.

The performance monitoring of the two sided CSI compression use case may reside at the network side, which requires collection of target CSI from the UE.

NW side may define the loss function and the side that can compare target CSI with the compressed CSI. This requires that the target CSI be reported to the network in live networks.

The loss function may be NW side proprietary and may take into account interactions with other algorithms in the NW side such as the MU-MIMO precoding algorithm. Hence, loss function may not be transferred to the UE side for monitoring purpose as it would require using a “plain vanilla” loss function which has suboptimal network performance.

Reporting of target CSI may be performed using signaling to avoid the complexity of handling multiple formats of such target CSI reporting for monitoring.

Moreover, the re-training and model switching in the UE of the two-sided CSI compression use case may be controlled by the network side and/or the UE side. A sudden change of the UE side encoder model may cause an unexpected performance drop and the operator needs to be aware of the cause of the performance change. A decoder fine tuning may be possible as the loss function may be assessed by the network side, while transparent updates of encoder side may be risky. Hence, the decoder side updates may require collection of target CSI from the UE.

The data collection framework may support a UE to collect data from multiple measurement occasions so that the UE can report the accumulated data to the NW. For the CSI compression use case, a measurement occasion may consist of a single RS resource.

The collected data for model training may include CSI-RS measurement data of the radio channel as well as non-radio-measurement data. The radio measurement data may include CSI from CSI-RS measurements expressed in the target CSI format and the non-radio measurement data may include for example CSI-RS configuration, cell-ID, time stamp and/or UE location to enable training of site/area specific models.

If the UE that performs the data collection has a model for CSI compression deployed already, the latent space information (encoder output) as would have been sent in the UCI needs also to be collected together with the target CSI, so the data collection report may contain all the information needed for decoder fine tuning and/or model monitoring. The target CSI and latent space encoder output may be collected by one and the same CSI-RS measurement. The accumulated data of one or multiple measurement occasions may be reported from the UE to the NW.

For NW data collection for model training for the CSI enhancement use case, a UE may log measurements performed on CSI-RS stored in a high resolution target CSI format in addition to the assistance information (e.g., time stamps, cell ID, and/or UE location) and if available, also the encoder output (latent space as sent over UCI) obtained from the same measurement as the target CSI.

A UE may perform measurements at configured measurement occasion and logs the measurement data together with non-radio measurement data and assistance information (if needed). The network may trigger data collection in cells where more data needs to be gathered for an enhancement of the decoder. The network may use site specific models and thus may need to collect more data for a particular site. The network may also trigger data collection for certain UEs for performance monitoring purpose.

In this case, the data logging interval may be equivalent to the measurement occasion interval, and it may be the periodicity for a UE to store measurement results and associated non-radio-measurement data. For NW data collection for model training for the CSI compression use case, it may be define the candidate values of measurement occasion interval (data logging interval) and duration to be used.

For UE-side data collection, where UE performs measurements for its own model training. For the CSI prediction use case, where AI/ML model is one sided on the UE, the UE-side data collection may be implemented. For example, the CSI measurement procedure may need to be enhanced.

There may be several implementations of model transfer between gNB and UE (and vice versa). The other alternatives with NW first training and passing of gradient or latent space to the UE in offline training may be possible as they allow the UE side to develop their own algorithm and use optimized hardware.

If the target CSI approach of eType-II based is used, there may be need for the UE to report details of the pre-processing to the gNB to enable that the gNB can fully interpret the decoder output. For example, assuming Type-II based CSI target definition and if L=10 SD basis is configured, the channel may be LOS and the UE can decide not to use all 10 SD basis vectors in the CSI report. In this case, the UE needs to convey information to the gNB about discarded SD basis vectors.

If the pre-processing contains removal of raw channel subspace (by the UE), information about the remaining subspace (e.g., the SD and FD basis vectors) may be reported to the network side along with the encoder output bits.

In an example, the UE may compute RI and CQI. UE may be configured with the channel and interference measurement resources and the CSI reference resource to meet the target transport bock error probability. CQI may be conditioned on PMI, RI, CRI.

In an AI/ML-based framework, there may not exist a well-defined PMI that the UE and gNB both can refer to. However, with the introduction of a target CSI, the CQI may be conditioned on the target CSI (as well as on the RI and CRI). The CQI may be then well-defined, and the UE behavior may be consistent and predictable by the network. Moreover, the implementation of CQI determination may be implemented independently of the AI/ML model, reducing complexity in testing, and deploying models. The CQI determination may not be restrictive in the sense that the UE may still use an AI/ML model (possibly integrated with channel estimation and/or CSI compression) to determine CQI.

The gNB may change the suggested precoder, e.g., for MU-MIMO scheduling. The gNB may be able to choose an MCS, that is possibly different from what was reported in the CQI, e.g., if the DL-precoder is changed in MU-MIMO scheduling. The gNB may handle that CQI is conditioned on a hypothesis that is not used for DL-precoding, as long as the conditioning is well-defined and resulting in predictable UE behavior.

In a case where the target CSI is explicit (full channel tensor), but the CSI reporting is implicit (precoder hypothesis), the CQI may be conditioned on the target CSI. The additional assumption may be that CQI is conditioned on that the RI number of strongest Tx-eigenvectors, of the target CSI, are used as precoder hypothesis.

If raw channel-based CSI reporting is supported (e.g., full Tx * Rx MIMO channel), then the CSI report may be similar to the CSI acquired by SRS measurements in TDD. A gNB may re-use the method to acquire rank and CQI used today for TDD reciprocity. In an example, the CQI and RI reporting is disabled.

In an example, the model LCM of a two-sided model not relying on model transfer may handle if the encoder is frozen and never changed after AI model deployment in UE.

The updating of the decoder may be transparent to the encoder side and by then avoid inter-vendor coordination for re-training. With CSI target and encoder output (i.e., decoder input) being occasionally reported jointly, the NW may autonomously monitor its decoder reconstruction error via an intermediate KPI defined by a loss function.

A detected drift of the intermediate KPI may initiate a re-training of the decoder, and if that cannot resolve the performance issue then one may consider also updating the encoder, i.e., a model switch (or model update) using FOTA and associated activation from NW side.

Such procedure for decoder model updating basically may follow the steps of initial training with NW model first in sequential training, with the difference that the second step of training the encoder is not needed.

The alternative to CSI targets being sent to the NW may be data collection over the top (OTT) to some UE-sided model LCM entity data repository for the purpose of model monitoring and re-training. Without having the associated NW decoder output and associated loss function, it may not be possible for the UE vendor to determine the KPI with deployed models, so the UE-side may monitor performance of its encoder with a reference decoder e.g., the decoder that was developed together with their encoder using an assumed reference loss function which is different from the loss function used by the NW side when performing the training of the actually deployed decoder.

If model drifts are detected using such approximate method on the UE side only monitoring, one UE-side may indicate that it has observed drifts whereas another UE-side is not indicating drifts, possibly due to a different reference decoder. Whether there is a need to initiate re-training of decoder only or both decoder and encoder will be unclear. However, with the principle of a single decoder in mind, such model LCM becomes complicated.

For example, the NW would have to understand if this drift is truly a drift with the actually deployed decoder or only in the UE's reference decoder. Moreover, since the decoder can be updated transparently to the encoder, the UE may not know when the decoder is updated, meaning that the UE may not be sure about the time scale over which it would aggregate the statistics and if the reference decoder is relevant or obsolete. The NW may know if the problem exists for many UEs or if it is prevalent in a single category of UEs.

Model monitoring of two-sided models using intermediate KPIs may be based on the fact that the UE can be triggered to report the target CSI together with the CSI report.

Model selection/switching may be considered in case a UE vendor has improved their model and downloaded a new model to the already deployed UEs in the field (e.g., using FOTA). This may be the case if more data has been collected to improve performance or to extend the applicability of AI-CSI to new scenarios such as a railway or stadium. The UE may be deployed with multiple models for the CSI compression feature already at the deployment, targeting different scenarios such as rural, urban high rise etc.

The control over whether a different model in the UE is activated and replaces the old model (for the same feature) or whether a model is selected among a set of supported models may be controlled by the network and operator. Model switching may impose deploying multiple encoder models.

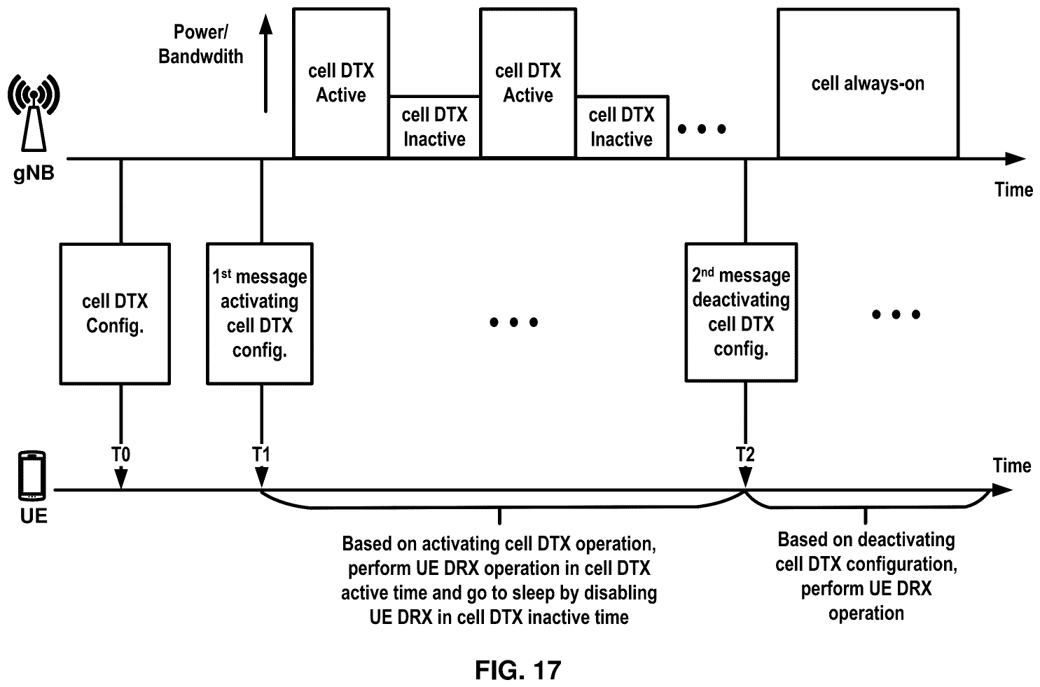

Jinsook Cell DTX submaster (from 23-1113P FIG. 34→FIG. 17)

FIG. 17 shows an example embodiment of cell DTX (which is similarly applied for cell DRX) for network energy saving. In an example, at a first time (e.g., T0), a wireless device (UE) may receive, and/or a base station (gNB) may transmit, one or more RRC messages comprising configuration parameters of a cell (or a plurality of cells). A cell may be implemented based on example embodiments described above with respect to FIG. 10. The cell may be a PCell/PSCell. In an example, the cell may be a SCell.

In an example, the one or more RRC messages may comprise configuration parameters (first parameters) of a DRX configuration specifically for the wireless device. The DRX configuration may be referred to as a UE specific DRX configuration (UE DRX configuration, C-DRX configuration, or DRX configuration). Different wireless devices may receive different configuration parameters of DRX configurations. The configuration parameters of the DRX configuration are specifically for a wireless device who receives the UE specific RRC message. In an example, the configuration parameters of a DRX configuration for the wireless device may comprise: a value of a DRX cycle (short cycle or long cycle) of the DRX configuration, a time offset value (drx_StartOffset) of a starting point of the DRX cycle, relative to a reference subframe (e.g., subframe 0 of a radio frame), a first timer value (drx-onDurationTimer) of a DRX on duration timer, a slot offset value (drx_SlotOffset) for a delay (e.g., a number of slots) before starting the DRX on duration timer at the beginning of a subframe, a second timer value (drx-InactivityTimer) of a DRX inactivity timer, a third timer value (drx-RetransmissionTimerDL or drx-RetransmissionTimerUL) of a DRX retransmission timer and/or a fourth timer value (drx-HARQ-RTT-TimerDL or drx-HARQ-RTT-TimerUL) of a DRX HARQ RTT timer.

In an example, the one or more RRC messages may comprise configuration parameters (second parameters) of a cell DTX configuration. The one or more RRC messages may comprise a cell common RRC message (e.g., MIB, SIB1/SIB2/SIB3/ . . . , etc.). The cell DTX configuration may be referred to as a cell level DTX configuration (or cell DTX configuration, DTX configuration, cell common DTX configuration, etc.), which is applied for all wireless devices in the cell. The configuration parameters of the cell DTX configuration may comprise a periodicity value of a cell DTX cycle of the cell DTX configuration, and a time offset value of a starting point of the cell DTX cycle. In an example, the configuration parameters of the cell DTX configuration may comprise at least one of: a first length indication of a first time period of a cell DTX Active Time (or a cell DTX on duration) of the cell DTX cycle and/or a second length indication of a second time period of a cell DTX inactive/non-active time (or a cell DTX off duration) of the DTX cycle.

In an example, the wireless device may receive a SCell activation/deactivation MAC CE indicating an activation of the cell, e.g., if the cell is a SCell. Based on receiving the SCell activation/deactivation MAC CE, the wireless device may activate the SCell. The wireless device may perform downlink receptions and/or uplink transmissions via the activated SCell.

In the example of FIG. 17, the wireless device may receive, at a second time (e.g., T1), a first message comprising parameters indicating an enabling (or triggering, activating, initiating, etc.) of the cell DTX configuration. The wireless device may receive the first message after the cell is activated (e.g., based on receiving a SCell activation/deactivation MAC CE indicating the activation of the cell) if the cell is an SCell.

In an example, the first message may comprise at least one of: a RRC message (which may be different from the one or more RRC messages, received in T0, configuring the UE DRX configuration and/or the cell DTX configuration), a MAC CE, a DCI, or any combination thereof. The MAC CE enabling the cell DTX configuration may be different from existing MAC CEs. The DCI enabling/activating the cell DTX configuration may be different from existing DCI formats. The DCI may be a group common DCI transmitted to a plurality of wireless devices in the cell.

In an example, when (or after) the cell DTX configuration is enabled/activated, in a first time duration of the cell DTX Active Time of a DTX cycle for the cell DTX configuration, the base station may transmit periodic downlink signals (e.g., SIBs/SSBs/CSI-RSs/TRSs), PDCCH/PDSCH, etc., as it does in the normal state of the cell. When (or after) the cell DTX configuration is enabled/activated, in a second time duration of the cell DTX inactive/non-active time of the DTX cycle for the cell DTX configuration, the base station may reduce transmission power/bandwidth/beam of the CSI-RSs, stop transmission of the CSI-RSs, and/or stop transmission of PDCCHs/PDSCHs, while the base station may keep transmitting MIB/SSBs/SIBs (which can be used for synchronization for legacy wireless devices or wireless devices in RRC_IDLE state or RRC_INACTIVE state).

In the example of FIG. 17, in response to receiving the first message indicating an enabling (or triggering, activating, initiating, etc.) of the cell DTX configuration, the wireless device may perform the UE DRX operation (if configured) according to both the first parameters of the UE DRX configuration and the second parameters of the cell DTX configuration. In response to receiving the first message indicating an enabling (or triggering, activating, initiating, etc.) of the cell DTX configuration, the wireless device may perform the cell DTX according to the second parameters of the cell DTX configuration if the UE DRX is not configured.

In an example, if UE DRX configuration is configured, the wireless device may perform the UE DRX operation comprising discontinuously monitoring PDCCH (for one or more RNTIs associated with UE DRX configuration) in the UE DRX Active Time (indicated by the first parameters) within the first time duration (indicated by the second parameters) of the cell DTX Active Time. The wireless device may skip PDCCH monitoring for the one or more RNTIs associated with the UE DRX operation in the UE DRX inactive time, which may be within the first time duration of the cell DTX Active Time or the second time duration of the cell DTX inactive time.

In an example, the wireless device may not be configured with a UE DRX configuration, in which case, the wireless device may monitor/receive MIB/SSBs/SIBs/CSI-RSs/PDSCHs/PDCCHs in the first time of the cell DTX Active Time of a cell DTX cycle of a cell DTX configuration and stop monitoring/receiving CSI-RSs/PDSCHs/PDCCHs in the second time of the cell DTX inactive time of the cell DTX cycle after the Cell DTX configuration is activated.

In the example of FIG. 17, the base station may determine to disable (or release, deactivate, clear, etc.) the cell DTX configuration, e.g., when there are more and more active wireless devices entering in the cell or moving into the cell, and/or when there are more and more (urgent) downlink/uplink data pending for transmissions. Staying (always) in the cell level DTX configuration (comprising periodic transitioning between cell DTX Active Time and cell DTX inactive time) may not ensure data transmission latency for these cases when there are more and more active wireless devices entering in the cell or moving into the cell, and/or when there are more and more (urgent) downlink/uplink data pending for transmissions. To improve the transmission latency, the base station may transmit, e.g., at T2, a second message indicating a disabling (or releasing, deactivating, clearing, etc.) of the cell DTX configuration. In response to deactivating the cell DTX configuration, the base station may resume the transmission of CSI-RSs/TRSs/PDCCHs/PDSCHs via the cell according to the configuration parameters of the downlink signals, in addition to keeping the transmissions of MIB/SSBs/SIBs via the cell.

In an example, the second message may comprise at least one of: a RRC message (which may be different from the first message, received in T1, enabling/activating the cell DTX configuration), a MAC CE, a DCI, or any combination thereof.

In the example of FIG. 34, the wireless device, based on receiving the second message disabling/deactivating the cell DTX configuration, may assume/determine that the cell is (always) in the power-on state (or the first power state/mode or the normal power state). Based on the disabling/deactivating of the cell DTX operation and the determining that the cell is in the power-on state (or the first power state/mode or the normal power state), the wireless device may perform the UE specific DRX operation (if configured), e.g., by ignoring the second parameters of the cell DTX configuration.

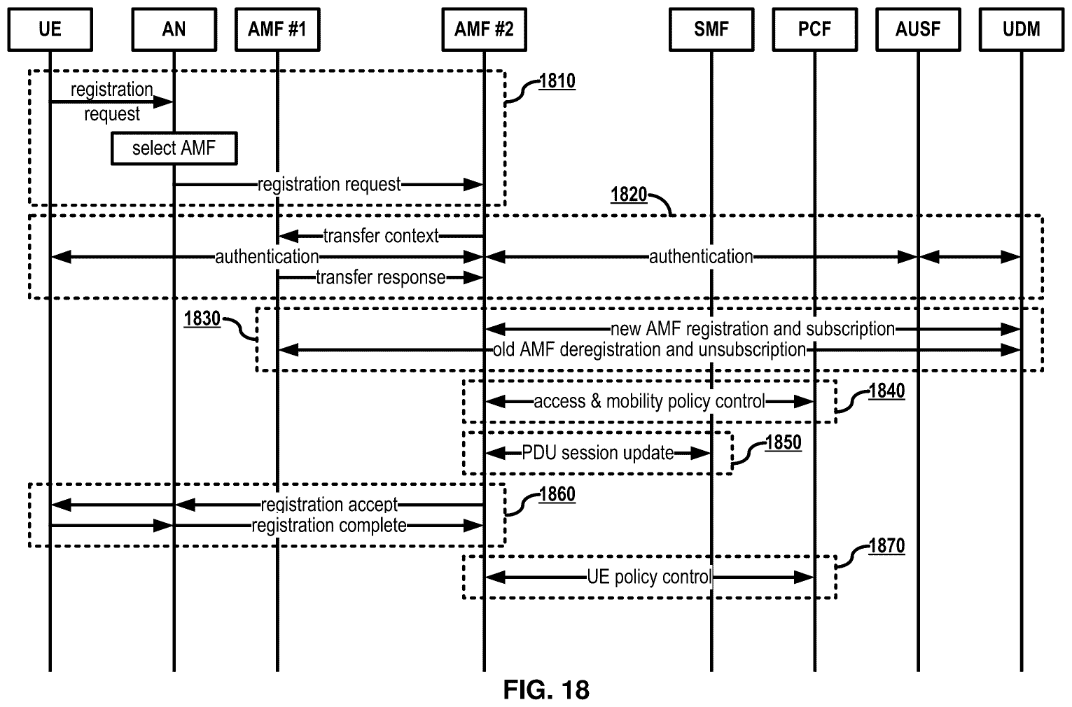

FIG. 18 illustrates an example of a registration procedure for a wireless device (e.g., a UE). Based on the registration procedure, the UE may transition from, for example, RM deregistered to RM registered. Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 18) may be performed to stop network access.

At 1810, the UE transmits a registration request to an AN. As an example, the UE may have moved from a coverage area of a previous AMF (illustrated as AMF #1) into a coverage area of a new AMF (illustrated as AMF #2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1820, the AMF that receives the registration request (AMF #2) performs a context transfer. The context may be a UE context, for example, an RRC context for the UE. As an example, AMF #2 may send AMF #1 a message requesting a context of the UE. The message may include the UE identifier. The message may be a Namf_Communication_UEContextTransfer message. AMF #1 may send to AMF #2 a message that includes the requested UE context. This message may be a Namf_Communication_UEContextTransfer message. After the UE context is received, the AMF #2 may coordinate authentication of the UE. After authentication is complete, AMF #2 may send to AMF #1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1830, the new AMF, AMF #2, registers and/or subscribes with the UDM. AMF #2 may perform registration using a UE context management service of the UDM (Nudm_UECM). AMF #2 may obtain subscription information of the UE using a subscriber data management service of the UDM (Nudm_SDM). AMF #2 may further request that the UDM notify AMF #2 if the subscription information of the UE changes. As the new AMF registers and subscribes, the old AMF, AMF #1, may deregister and unsubscribe. After deregistration, AMF #1 is free of responsibility for mobility management of the UE.

At 1840, AMF #2 retrieves access and mobility (AM) policies from the PCF. As an example, the AMF #2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP)) that influences routing to an established PDU session or a new PDU session. As noted above, different policies may be obtained and/or enforced based on subscription data of the UE, location of the UE (i.e., location of the AN and/or AMF), or other suitable factors.

At 1850, AMF #2 may update a context of a PDU session. For example, if the UE has an existing PDU session, the AMF #2 may coordinate with an SMF to activate a user plane connection associated with the existing PDU session. The SMF may update and/or release a session management context of the PDU session (Nsmf_PDUSession_UpdateSMContext, Nsmf_PDUSession_ReleaseSMContext).

At 1860, AMF #2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF #2. The registration complete message may acknowledge receipt of the new UE identifier and/or new configured slice identifier.

At 1870, AMF #2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

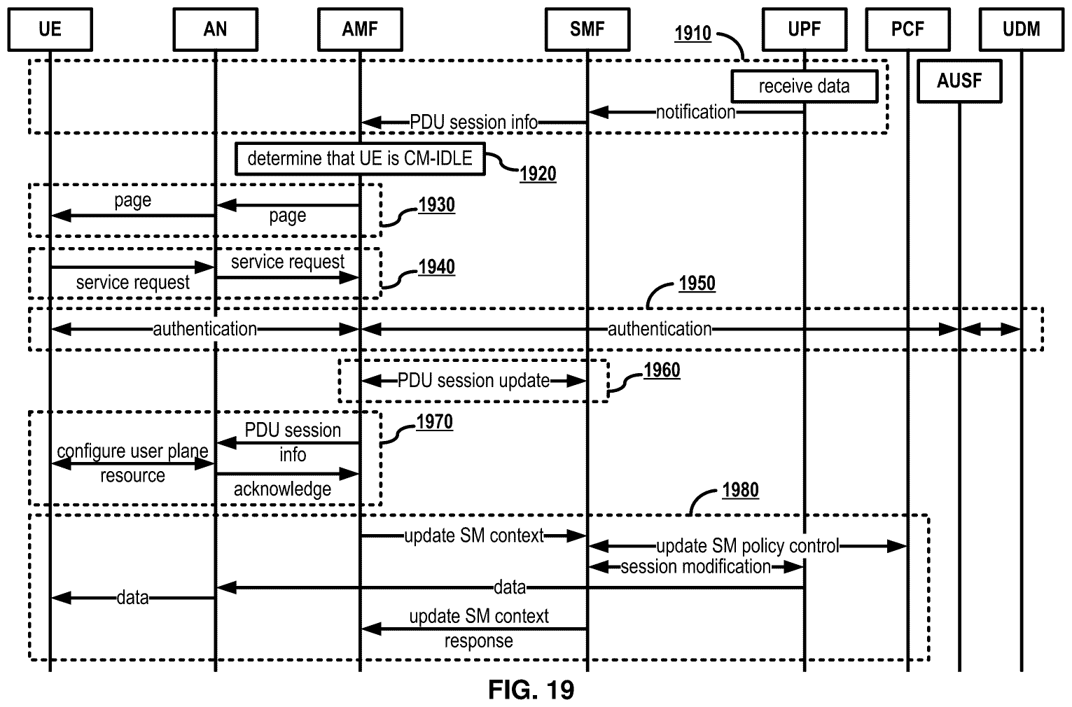

FIG. 19 illustrates an example of a service request procedure for a wireless device (e.g., a UE). The service request procedure depicted in FIG. 19 is a network-triggered service request procedure for a UE in a CM-IDLE state. However, other service request procedures (e.g., a UE-triggered service request procedure) may also be understood by reference to FIG. 19, as will be discussed in greater detail below.

At 1910, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1920, the AMF determines that the UE is in a CM-IDLE state. The determining at 1920 may be in response to the receiving of the PDU session information. Based on the determination that the UE is CM-IDLE, the service request procedure may proceed to 1930 and 1940, as depicted in FIG. 19. However, if the UE is not CM-IDLE (e.g., the UE is CM-CONNECTED), then 1930 and 1940 may be skipped, and the service request procedure may proceed directly to 1950.

At 1930, the AMF pages the UE. The paging at 1930 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1940, the UE may request service. The UE may transmit a service request to the AMF via the AN. As depicted in FIG. 19, the UE may request service at 1940 in response to receiving the paging at 1930. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1940.

At 1950, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1950 may be skipped.

At 1960, the AMF and SMF may perform a PDU session update. As part of the PDU session update, the SMF may provide the AMF with one or more UPF tunnel endpoint identifiers. In some cases (not shown in FIG. 19), it may be necessary for the SMF to coordinate with one or more other SMFs and/or one or more other UPFs to set up a user plane.

At 1970, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1970, a NAS service accept message from the AMF via the AN. After the user plane resource is configured, the UE may transmit uplink data (for example, the uplink data that caused the UE to trigger the service request procedure).

At 1980, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

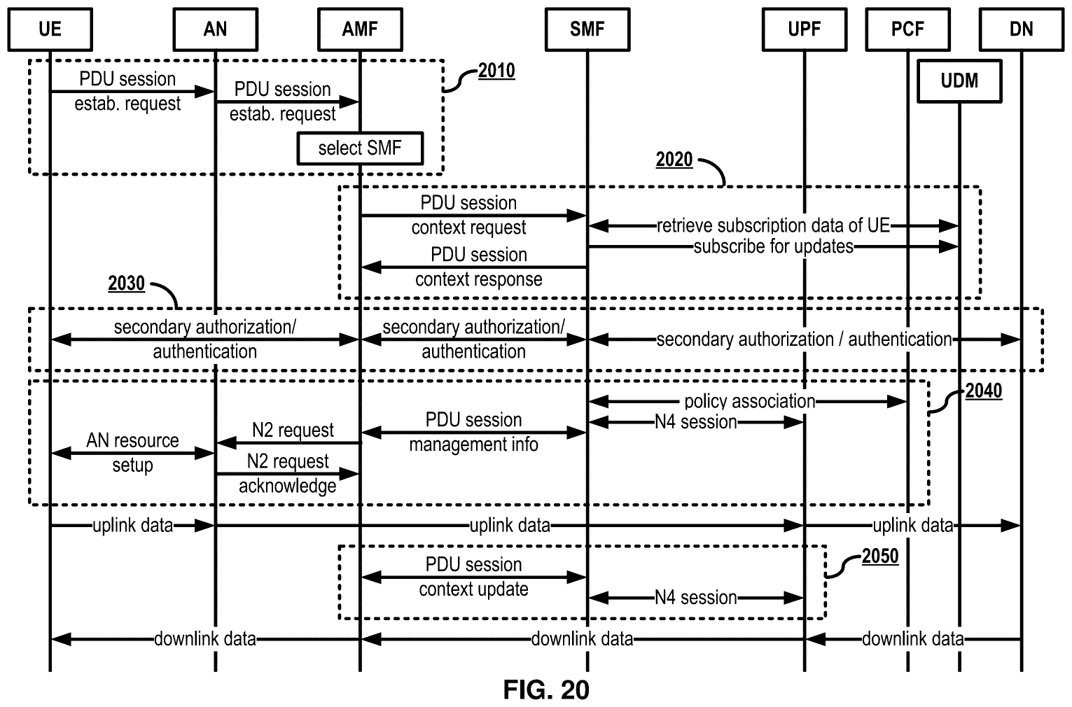

FIG. 20 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 2010, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S NSSAI); a requested SSC mode; and/or any other suitable information. The PDU session ID may be generated by the UE. The PDU session type may be, for example, an Internet Protocol (IP)-based type (e.g., IPv4, IPv6, or dual stack IPv4/IPv6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S NSSAI, and the SMF may be selected based on a determination that the SMF can manage a PDU session associated with the particular DNN and/or S NSSAI.

At 2020, the network manages a context of th0065 PDU session. After selecting the SMF at 2010, the AMF sends a PDU session context request to the SMF. The PDU session context request may include the PDU session establishment request received from the UE at 2010. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 2030, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 2040, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 13) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a session service request (e.g., Namf_Communication_N1N2MessageTransfer) message. The PDU session management information may include the PDU session ID. The PDU session management information may be a NAS message. The PDU session management information may include N1 session management information and/or N2 session management information. The N1 session management information may include a PDU session establishment accept message. The PDU session establishment accept message may include tunneling endpoint information of the UPF and quality of service (QoS) information associated with the PDU session.

The AMF may send an N2 request to the AN. The N2 request may include the PDU session establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU session establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 2040, the UE may optionally send uplink data associated with the PDU session. As shown in FIG. 20, the uplink data may be sent to a DN associated with the PDU session via the AN and the UPF.

At 2050, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 20, the downlink data may be received from a DN associated with the PDU session via the AN and the UPF.

In an example, energy consumption may be a significant source of operations costs for Mobile Network Operators (MNOs) and depending on the energy generation mix that may be used to power networks, it may also have impact on the environment. Energy efficiency and energy saving may be key factor for sustainable and social responsibility for the direction of the network technology (e.g., 5G/6G). The energy efficiency and energy saving may be possible by activating and deactivating parts of the network.

In an example, the goal of energy efficiency is to reduce energy for the same services. The goal of energy usage control as service criteria may be to supervise services in an energy-aware manner, ensuring the services are offered as intended by service providers, network operators or subscribers, with energy constraints and no performance consequences.

In an example, the goal of efficiency and energy saving may be possible by reducing the energy consumption for same services.

In an example, the goal of efficiency and energy saving may be possible by reducing the energy consumption for same services and may cause service performance degradation.

In an example, climate change may cause by excessive emissions of GHG (Green House Gas, e.g., carbon dioxide) due to human activity (e.g., burning fossil fuels for electricity generation) may be the main driver to climate change, which may pose a significant threat to society and the environment. Toward the goal of carbon neutrality, it may be important to reduce the GHG incl. carbon emissions in the first place rather than offset them later. Recent advancements in cellular technologies (e.g., 5GS) that may enable a wide range of applications has led to an explosive growth of service demands in networks. ICT (Information and communication technology) sector may be expected to account for 20% of the global energy consumption by 2040. 3GPP may play a crucial role in the ICT sector to enable the deployment of these technologies on a global scale and therefore must also play a central role in enabling a sustainable future.

In an example, to reduce the carbon footprint, telecom operators may utilize more renewable energy (e.g., solar, wind) that does not release carbon dioxide when producing electricity. The energy used by network may be from varied energy with different related levels of environmental impact incl. GHG emissions. Due to the highly variable and unpredictable nature of renewable energy sources, the supply of renewable energy may vary substantially by time and location.

In an example, telecom operator may provide communication service considering the supply of renewable energy, in which operator utilizes renewable energy sources in a best-effort manner while ensuring the QoS levels of services to be met.

In an example, 5G system operated by operator A may be powered by both of renewable energy (e.g., solar energy) and non-renewable energy (e.g., coal). The ratio of renewable energy may be determined as the ratio of the power that is used from renewable energy sources as a percentage of total power usage in a given time unit. Calculation of ratio of renewable energy may be done by means of averaging or applying a statistical model.

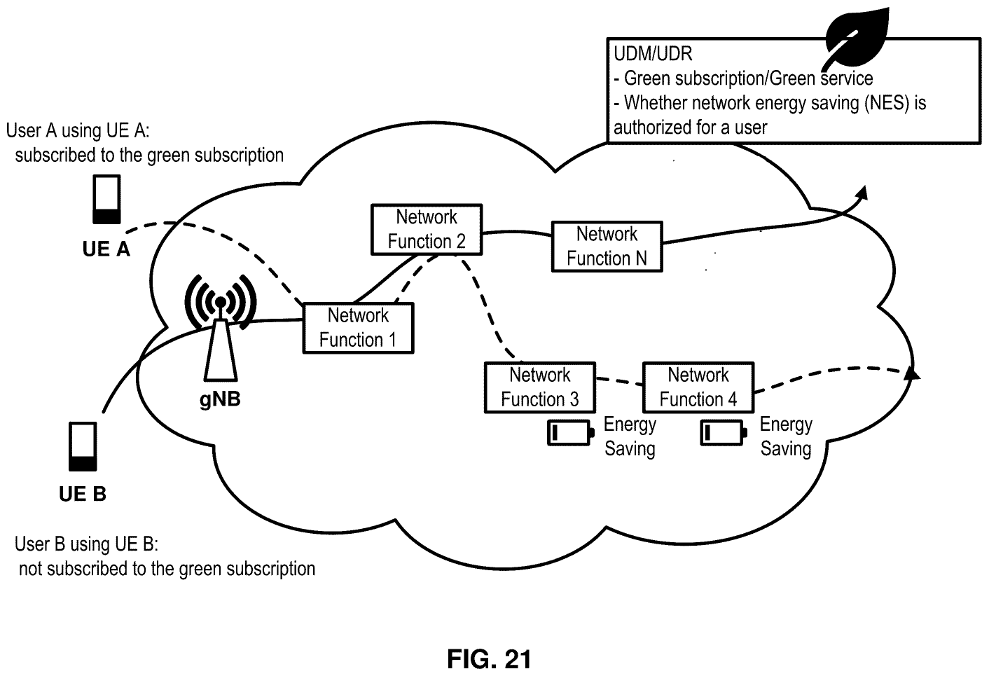

FIG. 21A illustrates an example of a core network architecture 2100A comprising an arrangement of multiple UPFs. Core network architecture 2100A includes a UE 2101, an AN 2102, an AMF 2112, and an SMF 2114. Unlike previous examples of core network architectures described above, FIG. 21A depicts multiple UPFs, including a UPF 2105, a UPF 2106, and a UPF 2107, and multiple DNs, including a DN 2108 and a DN 2109. Each of the multiple UPFs 2105, 2106, 2107 may communicate with the SMF 2114 via an N4 interface. The DNs 2108, 2109 communicate with the UPFs 2105, 2106, respectively, via N6 interfaces. As shown in FIG. 21A, the multiple UPFs 2105, 2106, 2107 may communicate with one another via N9 interfaces.

The UPFs 2105, 2106, 2107 may perform traffic detection, in which the UPFs identify and/or classify packets. Packet identification may be performed based on packet detection rules (PDR) provided by the SMF 2114. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QoS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 2105 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 2105 may perform data buffering of a certain number of downlink packets if a PDU session is deactivated.

The UPF 2105 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 2105 may mark packets belonging to a particular QoS flow with a corresponding QFI. The marking may enable a recipient of the packet to determine a QoS of the packet.

The UPF 2105 may provide usage reports to the SMF 2114 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 2108, 2109 may comprise public DNs (e.g., the Internet), private DNs (e.g., private, internal corporate-owned DNs), and/or intra-operator DNs. Each DN may provide an operator service and/or a third-party service. The service provided by a DN may be the Internet, an IP multimedia subsystem (IMS), an augmented or virtual reality network, an edge computing or mobile edge computing (MEC) network, etc. Each DN may be identified using a data network name (DNN). The UE 2101 may be configured to establish a first logical connection with DN 2108 (a first PDU session), a second logical connection with DN 2109 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

FIG. 21 illustrates an example of a green communication service option. The green communication service may be provided by the green subscription plan. An operator A may provide the green subscription plan/green cellular plan to the users. The green subscription plan may be associated with a user consent for the network energy saving (NES). The green subscription plan may be associated with a user consent for carbon emission reduction of the network operation. The energy saving/efficiency or the carbon emission reduction may require service performance degradation of the user. In an example, the service performance degradation may be for all services of the concerned wireless devices/UEs/users. In an example, wireless devices/UEs/users may be notified the potential service performance degradation in advance.

As illustrated in the FIG. 21, the user A of the UE A may be subscribed to the green subscription plan. The user A may consent the service performance degradation for the network energy saving. The user A may authorize the service performance degradation for the network energy saving. The user A may agree the service performance degradation for the network energy saving. The user A that allows/authorize the operators to save energy consumption by offering lower performance, may be for a best effort service or a best effort communication. The Operator A may provide credits (e.g., lower cost, additional data) to the user A as part of the green subscription plan. In an example, the best effort service/communication may be a type of traffic that is provided as a service to customers everything else being equal. For the best effort service/communication, the security, privacy or complexity principles may not be sacrificed. In an example, the best effort traffic may not be associated with QoS policy service performance level criteria. In an example, a user of the UE B may not subscribe to the green subscription plan/green cellular plan. The user of the UE B may not consent/authorize the service (performance) degradation for network energy saving/efficiency.

In an example, the UE A (with the user A subscription information/data plan) may register to the network via network function 1, network function 2. The network (e.g., network function 1, network function 2) may select further network functions (e.g., network function 3, network function 4) to serve the UE A. During registration, a UDM may provide the consent/authorization information to the network functions. Based on the consent/authorization information, the network functions may select power saving capable network functions to serve the UE A. In an example, the network functions may decide the quality of service (QoS) for the UE A. The network functions may configure lower level QoS for the UE A based on the consent/authorization.

In an example, the UE B (with the user A subscription information/data plan) may register to the network via network function 1, network function 2. The network (e.g., network function 1, network function 2) may select further network functions (e.g., network function 2) to serve the UE A. The network functions may not select any energy saving network functions based on the user of the UE B is not consented/authorized for the NES. The network functions may not configure lower level QoS for the UE B. The network functions may not configure lower level QoS for the UE B based on the absent of the consent/authorization.

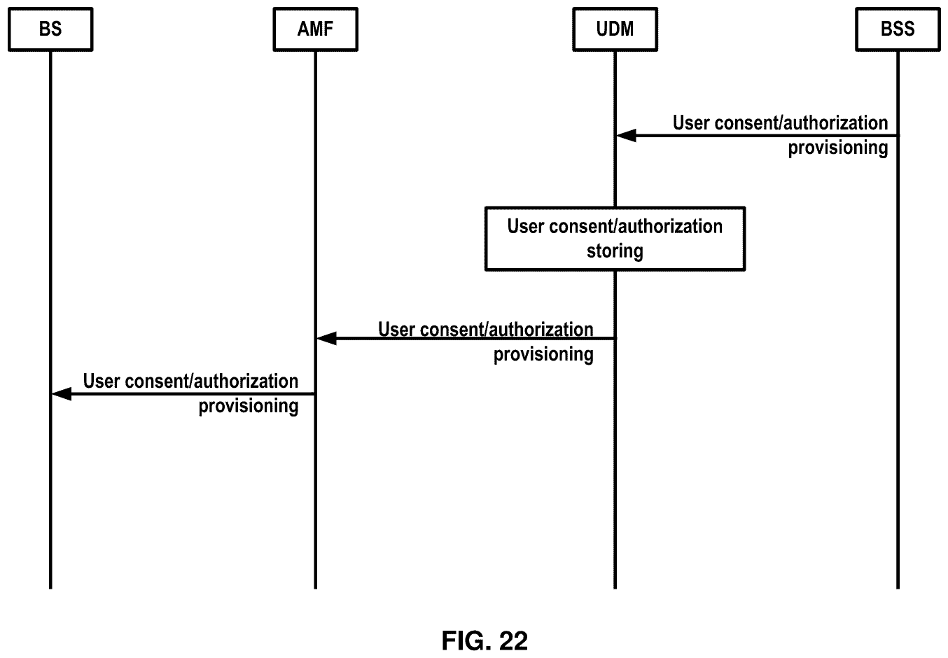

FIG. 22 illustrates the call flow for user consent/authorization handling. BSS (Business Support System) may provision/configure the user consent/authorization to a UDM. In an example, the provision may occur if a user purchases the cellular plan/cellular subscription plan. In an example, the user consent/authorization may indicate that the NES is authorized by the wireless device. In an example, the user consent/authorization may indicate that the NES is authorized by the network. The UDM may indicate the consent/authorization to the base station via the AMF.

In an example, subscription and policy control may support energy efficiency and energy saving as service criteria. The network operators/mobile network operators may provide a green service by green subscription. The green subscription may be a form of subscription where the user that allows the operators to save resources by offering lower performance for best effort communication when this can save resources e.g. energy usage. In exchange the user may get a lower subscription fee and periodic estimation on how much energy and/or carbon emission the user has contributed to saving. Green subscription. A green subscription indication (GSI) may be added to the access and mobility subscription information. The AMF may retrieve the subscription information from UDM during registration procedure as illustrated in the FIG. 18. The AMF may pass the GSI to the base station via N2 interface and the base station may store it in the radio access network user equipment (UE) context. In an example, the N2 interface may be between the AMF and the base station. It may be up to implementation how the base station uses the GSI. It maybe an additional input that base station can use to save resources when there are constraints for best effort services with the understanding that the GSI indicates that the subscriber has accepted that performance may decrease if it saves resources for the operator. In an example, the GSI may be the consent/authorization for the NES. The GSI may indicate that the NES is authorized by the wireless device. The GSI may indicate that the NES is authorized by network for the wireless device (e.g., UE B).

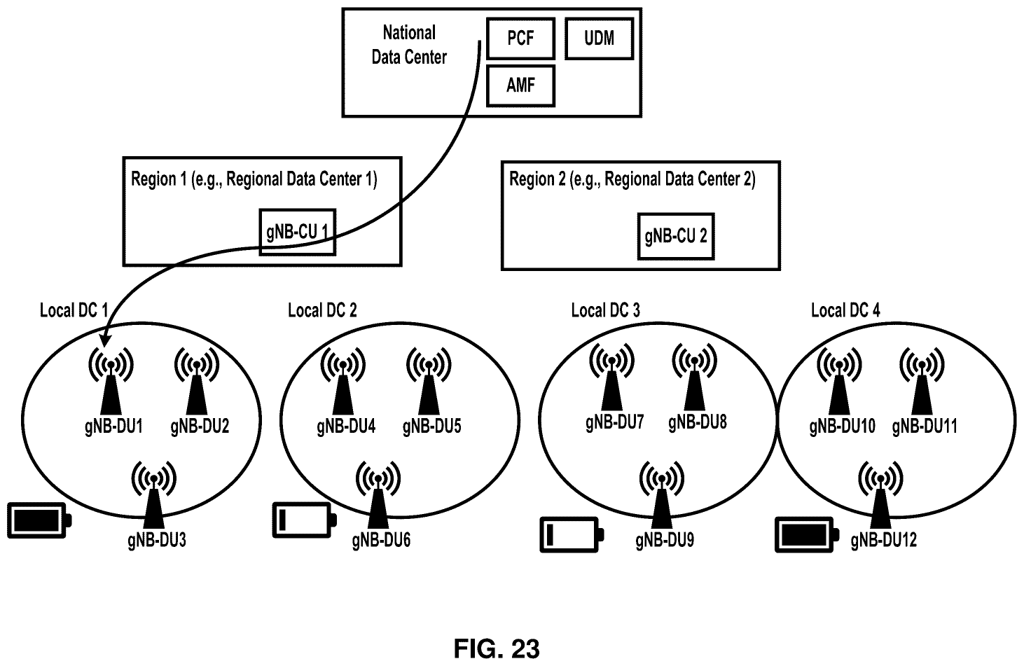

A wireless device/user/UE may allow the operator to save energy resources by offering lower performance. To allow the operator to save energy resources, the operator may use a parameter indicating that the user/UE authorize/consent the performance degradation if this can save the network energy. The parameter may be provided by the UDM to the base station via core network function (e.g., AMF) during attach and/or registration procedure. The base station may use the parameter to optimize the energy efficiency and/or energy saving. As shown in FIG. 23, the base station may be decomposed into multiple network nodes (e.g., gNB-CU 1, gNB-DU1, gNB-DU2) and the existing technology may not address if the network networks nodes of the base station are in a different location. In an example, gNB-DU1, gNB-DU2 and gNB-DU3 are in the local data center (DC) 1. gNB-DU4, gNB-DU5 and gNB-DU6 are in the local data center (DC) 2. In an example, the DC 1 may be in the New Jersey and the DC 2 may be in the Fairfax of Virginia. The energy source of the DC 1 and DC 2 may be different. In an example, the energy status (e.g., full energy, energy resource being limited) may be different. Passing the GSI to the base station may not resolve the scenario that the base station is decomposed into different areas. Passing the GSI to the base station may not reduce the energy consumption for the scenario that the base station is decomposed into many different areas.

In an existing technology, a wireless device (e.g., a user of the wireless device) may allow the operator to save network energy by offering lower performance of the wireless device. This may be realized by using a parameter indicating that the wireless device allows/authorizes the performance degradation if this can save the network energy. The base station may use the parameter to optimize the energy efficiency and/or energy saving of the network. However, passing the parameter from core network function to the base station may not resolve the scenario in which the base station is decomposed into different geographical areas.

Example embodiments of the present disclosure provide improved energy efficiency/saving for operators by allowing a central unit (CU) of a base station to communicate with a distributed unit (DU) of the base station regarding a network energy saving (NES) applicability of a DU, and whether the NES is authorized/activated by the network for a wireless device. Therefore, each DU can perform the optimal decision by using the local energy status for wireless devices accessing the DU. In an example, the DU may minimize to activate NES procedure if the local energy status of the DU is not limited. Accordingly, the individual wireless device can experience better performance even the wireless device allows the NES to save network energy.

In an example, the energy status may comprise high, middle and low. The energy status may be a number indicating the remaining of the energy of the network node (e.g., DU). Energy status may indicate if the energy is being limited or not. The network node may determine if the NES is needed or not based on the energy status.

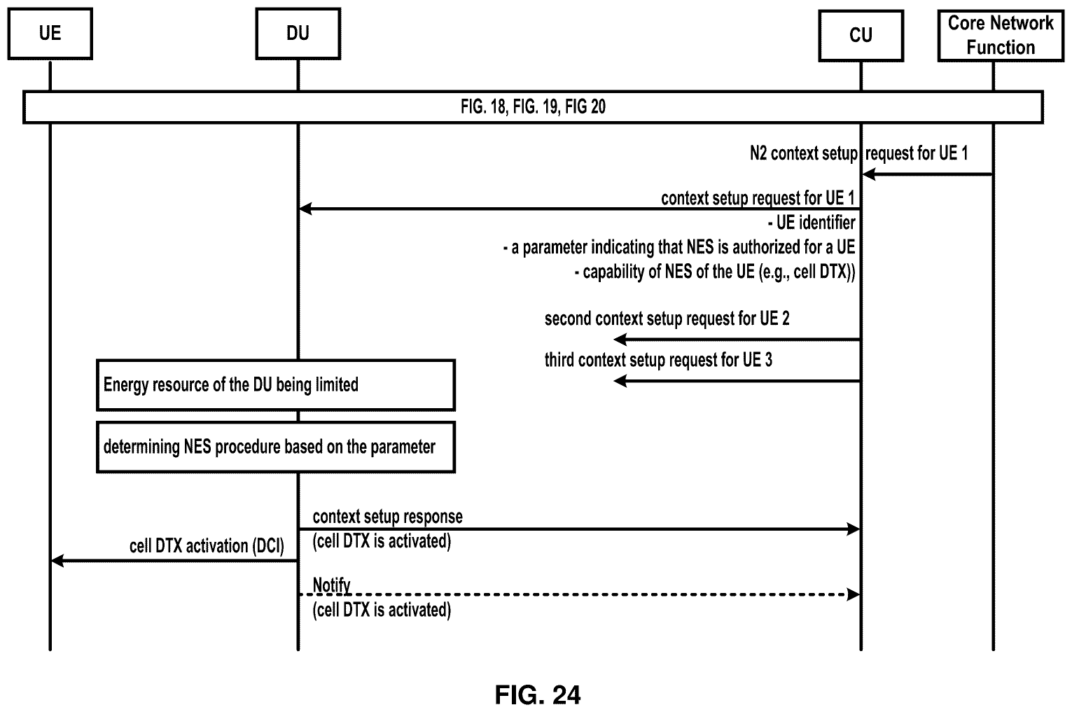

FIG. 24 illustrates an example as per an aspect of an embodiment of the present disclosure.

As described in FIG. 18, FIG. 19 and FIG. 20, a wireless device may register to the network. Registration may be initiated by a UE for the purpose es of obtaining authorization to access to the network (e.g., primary authorization) and receive services, enabling mobility tracking, enabling reachability, or other purposes. After the successful registration and get the authorization to access to the network. The wireless device may execute one or more PDU session establishment as shown in FIG. 20. The wireless device may access to one or more services via the one or more PDU sessions. As part of the registration and PDU sessions establishment, the DU, CU and the core network function may execute a context setup/modification procedure with the wireless device. The DU, CU and the core network function may execute the context setup/modification procedure with the wireless device for the purposes of setting up one or more radio connections between the wireless device and the network.

A central unit (CU) of a base station (BS) may send one or more messages comprising one or more parameters indicating that network energy saving (NES) is authorized for a wireless device. The CU may send the one or more messages in response to receiving N2 context setup request messages for one or more wireless devices from the core network function (e.g., AMF). Sending the one or more messages by the CU to DU may be part of a F1 operations for context setup of the wireless device. The one or more messages may be for one or more wireless devices, respectively. In an example, the CU may send the one or more messages to request contexts setup of the one or more wireless devices with the DU. In an example, the message may be a context setup request message. The purpose of the context setup for one or more wireless devices may be to establish the wireless device context including, among others, signaling radio bearer (SRB), data radio bearer (DRB), Uu Relay RLC channel, PC5 Relay RLC channel. Accordingly, the one or more wireless device can send and receive data packets with core networks via the DU and the CU. The one or messages may be context update messages. The context update to update the wireless device/UE contexts which setup with the context setup message. The DU may receive the one or more messages comprising one or more parameters indicating that NES is authorized for a wireless device. The parameter may indicate that NES is authorized for a wireless device. In an example, the parameter may indicate that a wireless device accepts a lower performance/performance degradation if it saves energy consumption, or it helps/assists energy saving of the network. In an example, the parameter may indicate that applying NES procedures is accepted/allowed to the wireless device/by the wireless device. The parameter may be based on green subscription. In an example, a user of the wireless device may subscribe to the green subscription. The user of wireless device may get a lower subscription fee for the green subscription. The parameter may be inherited from the UDM to the DU via the AMF and/or the CU.

In an example, the context setup request message may comprise a UE identifier, the parameter, capabilities for NES, SRB to be setup list, DRB to be setup list. In an example, the UE identifier may identify the wireless device during the F1 operations. The UE identifier may be a gNB-CU UE F1AP identifier/identity. The context setup request message may comprise the CU to DU RRC information. The CU to DU RRC information may comprise UE capability per RAT. As part of RF parameters of NR UE capability of the CU to DU RRC information may comprise the capabilities for the NES. The capabilities for the NES may be capability of the wireless device. The capabilities for the NES may comprise Cell DTX capability and/or the Cell DRX capability. The capabilities for the NES may comprise extended idle mode DRX, synchronization signal block deactivation, QoS degradation. Cell DTX capability and/or the Cell DRX capability. In an example, the SRB to be setup list may comprise information of one or more SRB (signal radio bearer) s to be established for the wireless device. Th DRB to be setup list may comprise information of one or more DRB (data radio bearer) to be established/setup for the wireless device.

The DU may determine whether to apply the NES for the wireless device. The DU may determine whether to apply one or more procedures of the NES for the wireless device. The DU may determine whether to apply one or more procedures of the NES to one or more cells for the wireless device. The DU may determine whether to apply the NES based on context setup request message. The DU may determine whether to apply the NES based on the parameter indicating that NES is authorized for the wireless device. The DU may determine whether to apply the NES based on the energy status of the DU. In an example, the NES may detect/determine that the energy of the DU is limited. In an example, the NES may detect/determine that the energy of the DU will be limited soon. The DU may determine whether to apply the NES based on the capabilities for the NES of the wireless device. The DU may determine whether to apply the NES based on the parameter, capabilities for the NES of the wireless device and/or the energy of the DU being limited.

The NES/NES procedure may be a mechanism to reduce energy consumption of the DU. The NES/NES procedure may be a mechanism to reduce energy consumption of the operator network. NES may comprise cell DTX (discontinuous transmission), cell DRX (discontinuous reception), extended connected/ide mode DRX, cell deactivation, synchronization signal block deactivation, quality of service (QoS) degradation, offering lower QoS. The NES procedure may reduce energy consumption by reducing the time of the activation of the network. The NES procedure may reduce energy consumption of the DU by reducing the time of the activation of the DU.

In response to the determining, the DU may send one or more indicators indicating an activation of the NES procedure. In an example, the NES procedure may be the cell DTX. The DU may send one or more indicator to the wireless device indicating an activation of a cell DTX of the one or more cells. In an example, the NES procedure may be the cell DRX. The DU may send one or more indicator to the wireless device indicating an activation of a cell DRX of the one or more cells. The DU may transmit DCI comprising the activation and/or deactivation of the cell DTX and/or cell DRX. In response to receiving the DCI, the wireless device may stop receiving and/or transmitting radio signal during configured period of the cell DRX and/or cell DTX. Later, the DU may determine that the energy of network/DU is not limited. The DU may send to the wireless device deactivation of the NES procedure.

In an example, the (network) energy may be electric energy or electric power. The energy may be measured in Joule (J) or Watthour (Wh). The DU may use the energy to operator the DU.

In response to determine to apply NES (e.g., cell deactivation), the DU may send to the CU information for the deactivation of one or more cells.

In response to receiving the context setup request message, the DU may send to the CU context setup response message. The context setup response message may comprise the UE identifier, applied NES procedure, DRB setup list, DRB failed Setup to setup list. The applied NES procedure may comprise cell DTX, cell DRX, extended idle mode DRX, cell deactivation, synchronization signal block deactivation, QoS degradation. If the applied NES procedure is the QoS degradation, the DU may indicate the amount of QoS degradation.

The DU may send notify message to the CU if any update happens. In an example, if the DU determines that the energy of network/DU is not limited, the DU may deactivation of the NES procedure. The DU may send the notify message comprising the updates.

In an example, a base station may comprise the DU and the CU. The location of the CU and the location of DU may be different. The CU may belong to a first data center and the DU may belong a second data center. The source of the energy of the CU and the DU may be different.

The parameter may be applicable for best effort service. The best effort service may be non-guaranteed bit rate service.

The DU may receive a second context setup request message for second wireless device. The second context setup request message may comprise a second parameter indicating the NES is not authorized for the second wireless device. DU may determine do not apply the NES procedure based on the parameter of the first wireless device (UE 1) and the second wireless device IUE 2). In an example, the first wireless device is authorized the NES based on the parameter, but the second wireless device is not authorized the NES based on the second parameter. The DU may determine do not apply NES for the cell both for the first and second wireless device.

In an example, a distributed unit (DU) from a central unit (CU) may receive a first message, requesting a first context setup of a first wireless device. The first message may comprise a parameter indicating that network energy saving (NES) is authorized/activated for the first wireless device. The DU may receive from the CU, a second message requesting a second context setup of a second wireless device. The second message may not indicate that the NES is authorized/activated for the second wireless device. The DU may determine that a NES (NES) procedure applies to the first wireless device, based on the parameter. Based on the determining, sending, by the DU to the CU, a third message indicating that the NES applies to the first wireless device.

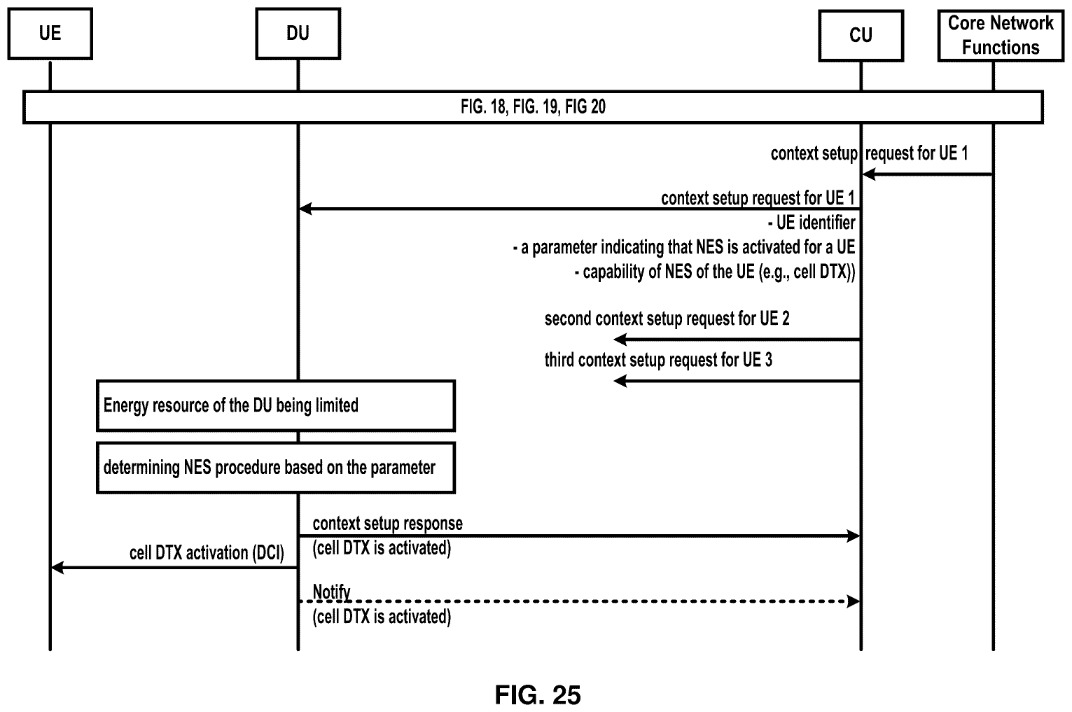

FIG. 25 illustrates an example as per an aspect of an embodiment of the present disclosure. As described in FIG. 18, FIG. 19 and FIG. 20, a wireless device may register to the network. Registration may be initiated by a UE for the purposes of obtaining authorization to access to the network (e.g., primary authorization) and receive services, enabling mobility tracking, enabling reachability, or other purposes. After the successful registration and get the authorization to access to the network. The wireless device may execute one or more PDU session establishment as shown in FIG. 20. The wireless device may access to one or more services via the one or more PDU sessions. As part of the registration and PDU sessions establishment, the DU, CU and the core network function may execute a context setup/modification procedure with the wireless device. The DU, CU and the core network function may execute the context setup/modification procedure with the wireless device for the purposes of setting up one or more radio connections between the wireless device and the network.

A central unit (CU) of a base station (BS) may send one or more messages comprising one or more parameters indicating that network energy saving (NES) is activated for a wireless device. Core network function (e.g., AMF) may send the one or more parameter to the CU for context setup procedure for the one or more wireless devices. In an example, the parameter may be based on subscription information of the one or more wireless devices. The subscription information may comprise NES strategy information for the one or more wireless devices. The NES strategy information may comprise a NES Allowed Indication indicating whether the NES operations is for the wireless device is allowed or not. This NES strategy information may be part of business agreement between the user of the wireless device and the operator. The core network function (e.g., AMF) may determine the parameter indicating that NES is activated for the wireless device, based on the subscription information comprising the NES strategy. In an example, the core network function may aware that the base station does not support the NES, the core network function may determine not to activate the NES for the wireless device. In an example, if the core network function aware that energy is not limited, the core network function may not activate the NES for the wireless device. The core network function may activate the NES for the wireless device, if the wireless device is allowed/authorized the NES per subscription information.

Sending the one or more messages by the CU to DU may be part of a F1 operations for context setup of the wireless device. The one or more messages may be for one or more wireless devices, respectively. In an example, the CU may send the one or more messages to request contexts setup of the one or more wireless devices with the DU. In an example, the message may be a context setup request message. The purpose of the context setup for one or more wireless devices may be to establish the wireless device context including, among others, signaling radio bearer (SRB), data radio bearer (DRB), Uu Relay RLC channel, PC5 Relay RLC channel. Accordingly, the one or more wireless device can send and receive data packets with core networks via the DU and the CU. The one or messages may be context update messages. The context update to update the wireless device/UE contexts which setup with the context setup request message. The DU may receive the one or more messages comprising one or more parameters indicating that NES is activated for a wireless device. The parameter may indicate that NES is activated for a wireless device. In an example, the parameter may indicate that a wireless device accepts a lower performance/performance degradation if it saves energy consumption, or it helps/assists energy saving of the network. In an example, the parameter may indicate that applying NES procedures is accepted/allowed to the wireless device/by the wireless device. The parameter may be based on green subscription. In an example, a user of the wireless device may subscribe to the green subscription. The user of wireless device may get a lower subscription fee for the green subscription. The parameter may be inherited from the UDM to the DU vis the AMF and/or the CU.

In an example, the context setup request message may comprise a UE identifier, the parameter, capabilities for NES, SRB to be setup list, DRB to be setup list. In an example, the UE identifier may identify the wireless device during the F1 operations. The UE identifier may be a gNB-CU UE F1AP identifier/identity. The context setup request message may comprise the CU to DU RRC information. The CU to DU RRC information may comprise UE capability per RAT. As part of RF parameters of NR UE capability of the CU to DU RRC information may comprise the capabilities for the NES. The capabilities for the NES may be capabilities of the wireless device for the NES. The capabilities for the NES may comprise Cell DTX capability and/or the Cell DRX capability. The capabilities for the NES may comprise extended idle mode DRX, synchronization signal block deactivation, QoS degradation. Cell DTX capability and/or the Cell DRX capability. In an example, the SRB to be setup list may comprise information of one or more SRB (signal radio bearer) s to be established for the wireless device. Th DRB to be setup list may comprise information of one or more DRB (data radio bearer) to be established/setup for the wireless device.

The DU may determine whether to apply/activate the NES for the wireless device. The DU may determine whether to apply one or more procedures of the NES for the wireless device. The DU may determine whether to apply one or more procedures of the NES to one or more cells for the wireless device. The DU may determine whether to apply the NES based on context setup request message. The DU may determine whether to apply the NES based on the parameter indicating that NES is activated for the wireless device. The DU may determine whether to apply the NES based on the energy status of the DU. In an example, the NES may detect/determine that the energy of the DU is limited. In an example, the NES may detect/determine that the energy of the DU will be limited soon. The DU may determine whether to apply the NES based on the capabilities for the NES of the wireless device. The DU may determine whether to apply the NES based on the parameter, capabilities for the NES of the wireless device and/or the energy of the DU being limited.

The NES/NES procedure may be a mechanism to reduce energy consumption of the DU. The NES/NES procedure may be a mechanism to reduce energy consumption of the operator network. NES may comprise cell DTX (discontinuous transmission), cell DRX (discontinuous reception), extended connected/ide mode DRX, cell deactivation, synchronization signal block deactivation, quality of service (QoS) degradation, offering lower QoS. The NES procedure may reduce energy consumption by reducing the time of the activation of the network. The NES procedure may reduce energy consumption of the DU by reducing the time of the activation of the DU.

In response to the determining, the DU may send one or more indicators indicating an activation of the NES procedure. In an example, the NES procedure may be the cell DTX. The DU may send one or more indicator to the wireless device indicating an activation of a cell DTX of the one or more cells. In an example, the NES procedure may be the cell DRX. The DU may send one or more indicator to the wireless device indicating an activation of a cell DRX of the one or more cells. The DU may transmit DCI comprising the activation and/or deactivation of the cell DTX and/or cell DRX. In response to receiving the DCI, the wireless device may stop receiving and/or transmitting radio signal during configured period of the cell DRX and/or cell DTX. Later, the DU may determine that the energy of network/DU is not limited. The DU may send to the wireless device deactivation of the NES procedure.

In response to determine to apply/activate NES (e.g., cell deactivation), the DU may send to the CU, information for the deactivation of one or more cells.

In response to receiving the context setup request message, the DU may send to the CU context setup response message. The context setup response message may comprise the UE identifier, applied NES procedure, DRB setup list, DRB failed Setup to setup list. The applied NES procedure may comprise cell DTX, cell DRX, extended idle mode DRX, cell deactivation, synchronization signal block deactivation, QoS degradation. If the applied NES procedure is the QoS degradation, the DU may indicate the amount of QoS degradation.

The DU may send notify message to the CU if any update happens. In an example, if the DU determines that the energy of network/DU is not limited, the DU may deactivation of the NES procedure. The DU may send the notify message comprising the updates.

In an example, a base station may comprise the DU and the CU. The location of the CU and the location of DU may be different. The CU may belong to a first data center and the DU may belong a second data center. The source of the energy of the CU and the DU may be different.

The parameter may be applicable for best effort service. The best effort service may be non-guaranteed bit rate service.

The DU may receive a second context setup request message for second wireless device. The second context setup request message may comprise a second parameter indicating the NES is not authorized for the second wireless device. DU may determine do not apply the NES procedure based on the parameter of the first wireless device (UE 1) and the second wireless device IUE 2). In an example, the first wireless device is authorized the NES based on the parameter. The second wireless device is not authorized the NES based on the second parameter. The DU may determine do not apply NES for the cell both for the first and second wireless device.

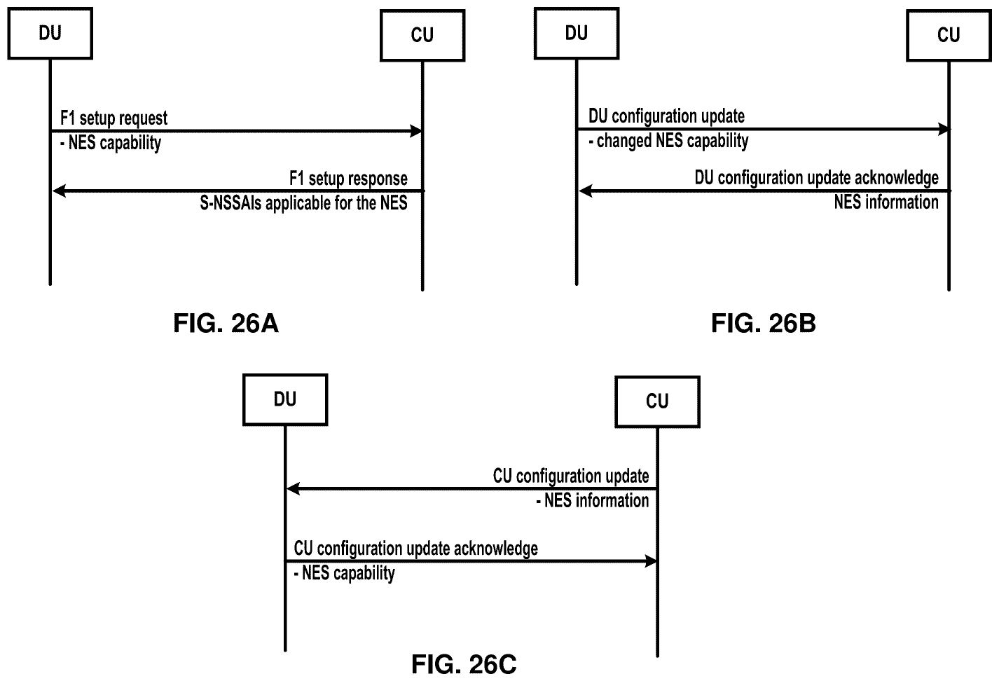

FIG. 26A, FIGS. 26B and 26C illustrates as per an aspect of an embodiment of the present disclosure. FIG. 26A illustrates interface setup procedure between a distributed unit (DU) of a base station and a central unit (CU) of the base station. The interface setup procedure may be to exchange application-level data needed for the DU and the CU correctly interoperate on the F1 interface. The interface may be F1 interface between the DU and the CU. The DU may send a setup request message to CU. The setup request message may comprise DU identifier/identity, served cells list by the DU, NES capability of the DU. NES capability may indicate that the DU is capable to support the NES procedure (e.g., cell DTX, cell DRX, SSB deactivation). NES capability may indicate that the DU can activate the NES procedure per wireless device. In an example, the CU may receive the setup request message from the CU. In response to receiving the setup request message, the CU may send to the DU setup response message. The setup response message may comprise CU identifier/identity, cells to be activated list, one or more first network slice identifiers which are allowed for the NES, one or more data network name (DNN) which are allowed for the NES. The network slice identifier may comprise S-NSSAI (single network slice selection assistance information). In an example, the DU may receive the setup response message. In response to receiving the setup response message, the DU may store the one or more network slice identifier which are allowed for the NES. Based on the received network slice identifier, the DU may determine which DRB of a wireless device is allowed to offer lower QoS performance. In an example, the DU receives from the CU, network slice A is allowed for the NES. Later, the DU can degrade/downgrade the QoS level (e.g., performance metric) of a DRB which is associated with the network slice A. In an example, network slice B is not allowed for the NES. Later, the DU doesn't degrade the performance of a DRB which is associated with the network slice B. In an example, slice B may be for a service requiring strict performance.

FIGS. 26B, 26C illustrates an interface update procedure after the setup (FIG. 26A) completed. FIG. 26B is for the case where the DU updates the DU's configuration to the CU. The DU may send DU configuration update message to the CU. The DU configuration update message may comprise transaction id, service cells to add list, served cells to modify list, the capability for the NES. In an example, the capability for the NES (e.g., NES capability of the DU) may be “DU is capable to activate the NES” during the setup procedure in FIG. 26A. The DU changed the NES capability to “DU is not capable to activate the NES” and the DU sends the change in the DU configuration update message. In an example, the DU determines that the energy of the DU is not limited. In an example, the DU is not capable to activate one or more NES procedures. In response to receiving the DU configuration update message, the CU may send a DU configuration update acknowledge.

FIG. 26 C is for the case where the CU updates the CU's configuration to the CU. In an example, the network slice identifiers which are allowed for the NES maybe changed. In an example, the one or more second network slices may be allowed for the NES. The CU may send a CU configuration update message to the DU. The CU configuration update message may comprise a transaction id, cells to be activated list, one or more second network slice identifiers which are allowed for the NES. In response to receiving the CU configuration update message, the DU may send a CU configuration update acknowledge message to the CU. The CU may delete the one or more first network slices and store the one or more second network slices for the network slice which is allowed for the NES.

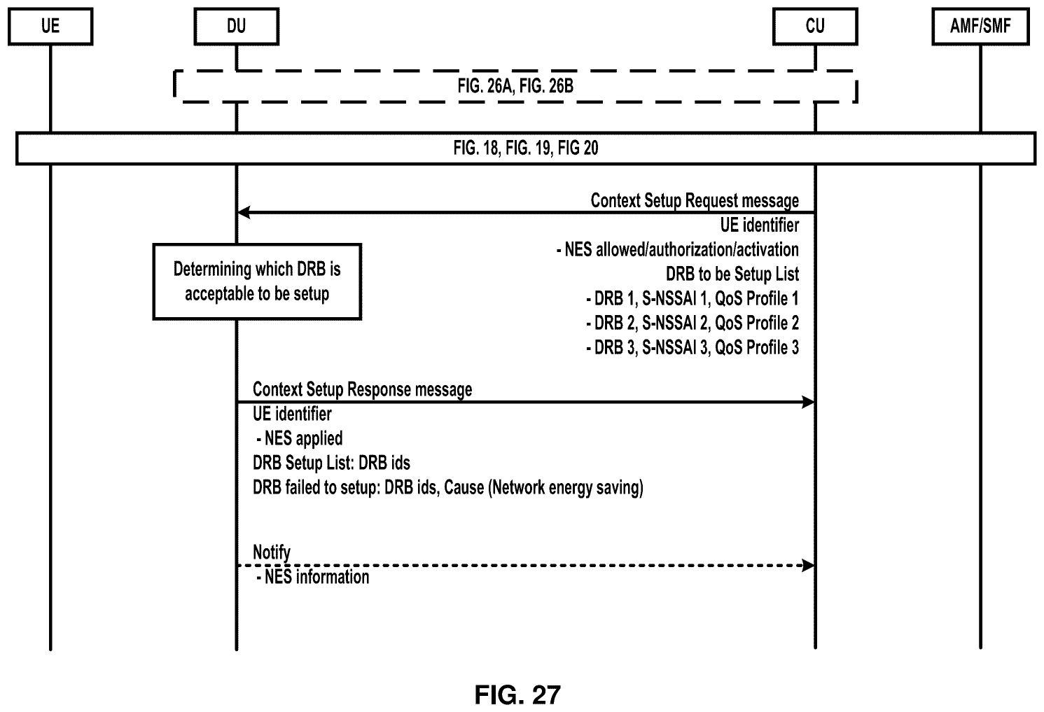

FIG. 27 illustrates an example as per an aspect of an embodiment of the present disclosure. As part of a registration and PDU sessions establishment as shown in FIG. 18, FIG. 19 and FIG. 20, the DU, CU and the core network function may execute a context setup/modification procedure with the wireless device. The DU, CU and the core network function may execute the context setup/modification procedure with the wireless device for the purposes of setting up one or more radio connections between the wireless device and the network. This example embodiment shows how session(s) setup and applying NES (e.g., downgrade/lowering the QoS level) per session/DRB between the DU and the CU, based on the parameter.

In an example, The DU may aware that which network slice is applicable the NES. Applying NES may be applying lower QoS to save network energy. One or more network slices which is applicable for the NES may be locally configured in the DU per O&M manner. Alternatively, the one or more network slices applicable for the NES may be explicitly indicated by the CU to the DU as shown in the FIG. 26A and FIG. 26B.

In an example, the central unit (CU) may receive a message requesting a context setup with a wireless device. The message may be a context setup request message. The message may comprise a UE identifier, a parameter, SRB to be setup list, DRB to be setup list. In an example, the UE identifier may identify the wireless device during the F1 operations. The UE identifier may be a gNB-CU UE F1AP identifier/identity. The parameter may indicate that the NES is allowed/authorized or not for the wireless device. The parameter may indicate that the NES is allowed/authorized or not for the wireless device by the network. The parameter may indicate that the NES is activated or not for the wireless device by the network. The NES authorized/allowed/activated for the wireless device may indicate that the wireless device allows/accepts or not a performance degradation of the wireless device. The NES authorized/allowed/activated for the wireless device may indicate that the DU can offer lower QoS level for the wireless device to save network energy. The DRB (Data Radio Bearer) to be setup list may indicate one or more session/DRBs need to be setup/establish for the wireless device to access one or more service. In an example, the DRB to be setup list may comprise one or more identifiers of a DRB to be setup. The DRB to be setup list may further comprise S-NSSAI (single network slice selection assistance information) per DRB, QoS parameters per DRB. The S-NSSAI may indicate a specific network slice which is associated with the DRB. The QoS parameters may be QoS flow level QoS parameters. The QoS parameters may comprise 5QI, NG-RAN allocation and retention priority, PDU session id associated with the DRB, Aggregate Maximum Bit Rate (AMBR). The 5QI may be a scalar that is used as a reference to 5G QoS characteristics that control QoS forwarding treatment for the QoS Flow (e.g. scheduling weights, admission thresholds, queue management thresholds, link layer protocol configuration, etc.). NG-RAN allocation and retention priority may be for retention and preemption of QoS flows. The AMBR may be a session AMBR. The AMBR may be a session AMBR for uplink direction. AMBR may limit the aggregate bit rate that can be expected to be provided across all Non-GBR QoS Flows for a specific PDU Session. The AMBR may indicate performance level of the session/DRB. In an example, higher AMBR may provide better performance for a service by allowing more bit rates for the service. Lower AMBR may provide lower performance for the service by limiting the bit rates for the service.

The DU may receive the message from the CU. The message may be the context setup request message. In response to receiving the message, the DU may determine which DRB is acceptable among the DRB to be setup list, and/or the QoS parameters/level per DRB. The determination may be based on the message, energy status (e.g., whether the energy being limited) of the DU. The determination may be based on the network slices (e.g., S-NSSAI) which are applicable for the NES. The determination may be based on the parameter, the DRB to be setup list and energy status of the DU and signal load status of the UE. In an example, the energy is limited for the DU. The DU may determine to activate NES for all wireless device accessing to the DU. In an example, the DU may determine to activate NES for one or more wireless devices but not all. Determining to activate the NES for the one or more devices based on the parameter. The DU may activate the NES for a wireless device which allows/authorizes the NES based on the parameter. Activating the NES may be offering lower QoS level for the wireless device or one or more DRBs/session of the wireless device.

In response to receiving the message and/or determination, the DU may send a response message to the CU. The response message may be a context setup response message. The response message may comprise a UE identifier, an indicator indicating whether the NES is applied or not, DRB setup list, DRB failed to setup list. The UE identifier may identify the wireless device during the F1 operations. The UE identifier may be a gNB-CU UE F1AP identifier/identity. The UE identifier may be a gNB-DU UE F1AP identifier/identity. The indicator may indicate if the NES is applied or not. The indicator may indicate if the DU applied NES for the wireless device. The indicator may indicate lower QoS applied for the wireless device. The indicator may comprise further information that how much lower AMBR applied for the wireless device. The indicator may comprise information that how much the wireless device is scarified their own performance for the Network energy saving. The DRB setup list may comprise one or more DRB identities/identifiers which are successfully accepted to be setup the radio bearer by the DU. The DRB setup list may further comprise information indicating if the NES applied for the DRB and QoS parameters used for the DRB. In an example, the information may indicate that a lower QoS level (e.g., lower AMBR) is applied for the DRB. The information may indicate second QoS level which applied for the DRB. The second QoS level may be different from the QoS level in the DRB to be setup list in the context setup request message. In an example, the DRB failed to setup list may comprise one or more DRB identities/identifiers which is failed to setup the radio bearers. In an example, the DRB failed to setup list may comprise one or more DRB identities, that is not accepted to setting up the radio bearers by the DU. The DRB failed to setup list may further comprise a cause value for a failure (e.g., not accepted). The cause value for the failure may comprise network energy saving (NES), not enough network energy, control processing overload, not enough user plane processing resources, hardware failure, O&M intervention. In an example, the DU may not accept a DRB X to save network energy. If the DU didn't accept the DRB X to save network energy or there is not enough network energy (e.g., network energy being limited), DU indicate the appropriate cause value (e.g., NES, not enough network energy, network energy being limited) in the DRB failed to setup list. In response to receiving the response message, the CU may continue the session establishment/activation procedure with core network function (e.g., AMF. SMF). The CU may use the cause value for future execution. The CU may indicate the cause value to the core network and core network node use this cause value for future management. In an example, the cause value may indicate NES or “not enough network energy”. The core network node may downgrade the QoS parameters for DRB of a wireless device accessing to the DU.

In an example, the DU may detect of NES applicability and/or NES strategy. In an example, the DU may determine deactivation of NES per UE or per DRB/session of a UE. The DU may send notify message to the CU, notifying the change of the NES applicability.

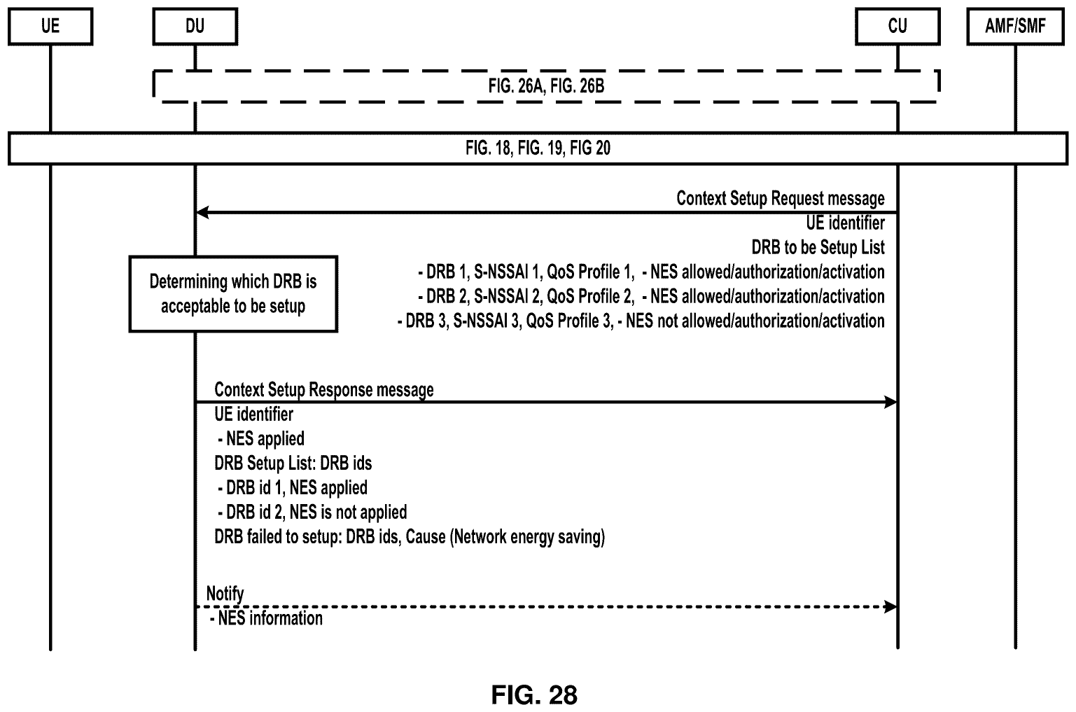

FIG. 28 illustrates an example as per an aspect of an embodiment of the present disclosure. This example embodiment may be a variance to the other example embodiment shown in FIG. 27. The CU may send a context setup request message. The context setup request message may comprise a UE identifier, SRB to be setup list, DRB to be setup list. In an example, the UE identifier may identify the wireless device during the F1 operations. The UE identifier may be a gNB-CU UE F1AP identifier/identity. The DRB (Data Radio Bearer) to be setup list may indicate one or more session/DRBs need to be setup/establish for the wireless device to access one or more service. In an example, the DRB to be setup list may comprise one or more identifiers of a DRB to be setup. The DRB to be setup list may further comprise S-NSSAI (single network slice selection assistance information) per DRB, QoS parameters per DRB, and a parameter. The parameter may indicate that the NES is allowed/authorized or not for the DRB/session. The parameter may indicate that the NES is allowed/authorized or not for the DRB/session of the wireless device by the network. The parameter may indicate that the NES is activated or not for the DRB/session of the wireless device by the network. The NES authorized/allowed/activated for the DRB/session may indicate that the DRB/session is allowed/accepted or not for the performance degradation. The NES authorized/allowed/activated for the DRB/session may indicate that the DU can offer lower QoS level for the DRB/session to save network energy. The S-NSSAI may indicate a specific network slice which is associated with the DRB. The QoS parameters may be QoS flow level QoS parameters. The QoS parameters may comprise 5QI, NG-RAN allocation and retention priority, PDU session id associated with the DRB, Aggregate Maximum Bit Rate (AMBR). The 5QI may be a scalar that is used as a reference to 5G QoS characteristics that control QoS forwarding treatment for the QoS Flow (e.g. scheduling weights, admission thresholds, queue management thresholds, link layer protocol configuration, etc.). NG-RAN allocation and retention priority may be for retention and preemption of QoS flows. The AMBR may be a session AMBR. The AMBR may be a session AMBR for uplink direction. AMBR may limit the aggregate bit rate that can be expected to be provided across all Non-GBR QoS Flows for a specific PDU Session. The AMBR may indicate performance level of the session/DRB. In an example, higher AMBR may provide better performance for a service by allowing more bit rates for the service. Lower AMBR may provide lower performance for the service by limiting the bit rates for the service.

The DU may receive the message from the CU. The message may be the context setup request message. In response to receiving the message, the DU may determine which DRB is acceptable among the DRB to be setup list, and/or the QoS parameters/level per DRB. The DU may additionally determine that which DRB among the DRB to be setup list is applicable for the NES. The determination may be based on the message, energy status (e.g., whether the energy being limited) of the DU. The determination may be based on the network slices (e.g., S-NSSAI) which are applicable for the NES. The determination may be based on the parameter in the DRB to be setup list and energy status of the DU and signal load status of the UE. In an example, the energy may be limited for the DU. In an example, the DU may determine to activate NES for DRB 1 and DRB 2 but not for DRB 3. In an example, the parameter associated with the DRB 1 and DRB 2 indicates that NES is allowed/authorized/activated for the DRB 1 and DRB 2. In an example, the parameter associated with the DRB 3 indicates that NES is not allowed/authorized/activated for the DRB 3. Determining to activate the NES for the one or more DRB/sessions of the wireless device may be based on the parameter. The DU may activate the NES for a DRB/session which allows/authorizes the NES based on the parameter by the CU. Activating the NES may be offering lower QoS level for the one or more DRBs/session of the wireless device.

In response to receiving the message and/or determination, the DU may send a response message to the CU. The response message may be a context setup response message. The response message may comprise a UE identifier, an indicator indicating whether the NES is applied or not, DRB setup list, DRB failed to setup list. The UE identifier may identify the wireless device during the F1 operations. The UE identifier may be a gNB-CU UE F1AP identifier/identity. The UE identifier may be a gNB-DU UE F1AP identifier/identity. The indicator may indicate if the NES is applied or not. The indicator may indicate if the DU applied NES for the wireless device. The indicator may indicate lower QoS applied for the wireless device. The indicator may comprise further information that how much lower AMBR applied for the wireless device. The indicator may comprise information that how much the wireless device is scarified their own performance for the Network energy saving. The DRB setup list may comprise one or more DRB identities/identifiers which are successfully accepted to be setup the radio bearer by the DU. The DRB setup list may further comprise information indicating if the NES applied for the DRB/session and QoS parameters used for the DRB. In an example, the information may indicate that a lower QoS level (e.g., lower AMBR) is applied for the DRB. The information may indicate second QoS level which applied for the DRB. The second QoS level may be different from the QoS level in the DRB to be setup list in the context setup request message. In an example, the DRB failed to setup list may comprise one or more DRB identities/identifiers which is failed to setup the radio bearers. In an example, the DRB failed to setup list may comprise one or more DRB identities, that is not accepted to setting up the radio bearers by the DU. The DRB failed to setup list may further comprise a cause value for a failure (e.g., not accepted). The cause value for the failure may comprise network energy saving (NES), not enough network energy, control processing overload, not enough user plane processing resources, hardware failure, O&M intervention. In an example, the DU may not accept a DRB X to save network energy. If the DU didn't accept the DRB X to save network energy or there is not enough network energy (e.g., network energy being limited), DU indicate the appropriate cause value (e.g., NES, not enough network energy, network energy being limited) in the DRB failed to setup list. In response to receiving the response message, the CU may continue the session establishment/activation procedure with core network function (e.g., AMF. SMF). The CU may use the cause value for future execution. The CU may indicate the cause value to the core network and core network node use this cause value for future management. In an example, the cause value may indicate NES or “not enough network energy”. The core network node may downgrade the QoS parameters for DRB of a wireless device accessing to the DU.

In an example, the DU may detect of NES applicability and/or NES strategy. In an example, the DU may determine deactivation of NES per UE or per DRB/session of a UE. The DU may send notify message to the CU, notifying the change of the NES applicability.

Example embodiment of in FIG. 27, the activation of the NES per DRB/session may be common to all wireless devices. For example, S-NSSAI X is applicable for the NES. If wireless device A and wireless device B is allowed/authorized/activated for the NES, the DRBs of the wireless device A and wireless device B, associated with the S-NSSAI-X, the DU may commonly apply the NES (e.g., providing lower QoS). Example embodiment of the FIG. 28, the activation of the NES per DRB/session may be different per wireless devices. For the DRB associated with the same network slice (e.g., S-NSSAI X), the DU may activate the NES for wireless device 1 but DU may deactivate the NES for the wireless device 2.

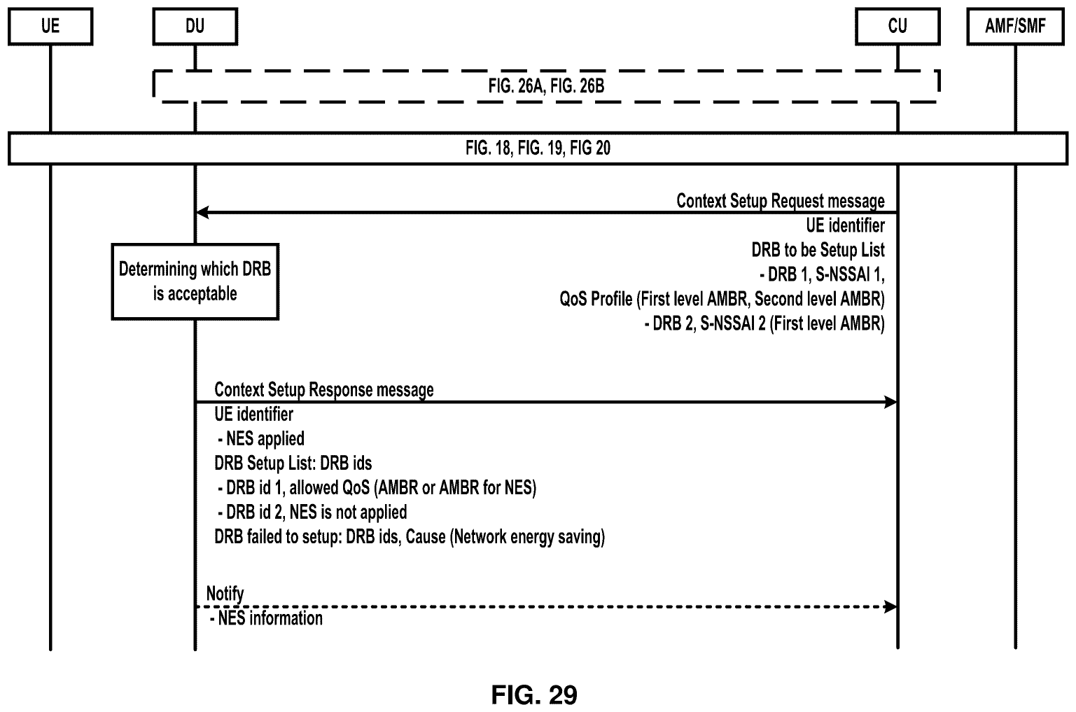

FIG. 29 illustrates an example as per an aspect of an embodiment of the present disclosure. This example embodiment a variance to the other example embodiment shown in FIG. 28. The CU may send a context setup request message. The context setup request message may comprise a UE identifier, SRB to be setup list, DRB to be setup list. In an example, the UE identifier may identify the wireless device during the F1 operations. The UE identifier may be a gNB-CU UE F1AP identifier/identity. The DRB (Data Radio Bearer) to be setup list may indicate one or more session/DRBs need to be setup/establish for the wireless device to access one or more service. In an example, the DRB to be setup list may comprise one or more identifiers of a DRB to be setup. The DRB to be setup list may further comprise S-NSSAI (single network slice selection assistance information) per DRB, first QoS parameters for the DRB, second QoS parameters for the DRB. The S-NSSAI may indicate a specific network slice which is associated with the DRB. The second QoS parameter may be present for one or more DRB/session which is allowed/authorized/activated for the NES. The second QoS parameter may be absent for one or more DRB/session which is not allowed/authorized/activated for the NES.

In an example, the first QoS parameters may be QoS flow level QoS parameters which is used a scenario when the network energy not being limited. The second QoS parameters may be QoS flow level QoS parameters which is used a scenario when the network energy being limited or NEX is activated. The first QoS parameters may comprise first 5QI, first NG-RAN allocation and retention priority, PDU session id associated with the DRB, first Aggregate Maximum Bit Rate (AMBR). The first 5QI may be a scalar that is used as a reference to 5G QoS characteristics that control QoS forwarding treatment for the QoS Flow (e.g. scheduling weights, admission thresholds, queue management thresholds, link layer protocol configuration, etc.). The first NG-RAN allocation and retention priority may be for retention and preemption of QoS flows. The first AMBR may be a session AMBR. The first AMBR may be a session AMBR for uplink direction. The first AMBR may limit the aggregate bit rate that can be expected to be provided across all Non-GBR QoS Flows for a specific PDU Session. The first AMBR may indicate performance level of the session/DRB. The second QoS parameters may comprise second 5QI, second NG-RAN allocation and retention priority, PDU session id associated with the DRB, second Aggregate Maximum Bit Rate (AMBR). The second 5QI may be a scalar that is used as a reference to 5G QoS characteristics that control QoS forwarding treatment for the QoS Flow (e.g. scheduling weights, admission thresholds, queue management thresholds, link layer protocol configuration, etc.). The second NG-RAN allocation and retention priority may be for retention and preemption of QoS flows. The second AMBR may be a session AMBR. The second AMBR may be a session AMBR for uplink direction. The second AMBR may limit the aggregate bit rate that can be expected to be provided across all Non-GBR QoS Flows for a specific PDU Session. The second AMBR may indicate performance level of the session/DRB. In an example, the first QoS parameters may requires more network energy than the second QoS parameters. The first QoS parameters may provide better service performance than the second QoS parameters.

In an example, the first 5QI and the second 5QI may be same. The first NG-RAN allocation and retention priority and the second NG-RAN allocation and retention priority may be same. In an example, the first AMBR may be higher than the second AMBR. The first AMBR may provide better QoS/performance for the wireless device.

The DU may receive the message from the CU. The message may be the context setup request message. In response to receiving the message, the DU may determine applicable QoS parameter for each DRB. If the second QoS parameter is absent for a DRB 1, the DU may apply the first QoS parameter for the DRB. If the second QoS parameter is present for a DRB 2, the DU may determine the applicable QoS parameter for DRB 2 among first QoS parameters and the second QoS parameters. In an example, the network energy of the DU is limited. The DU may determine network energy saving is needed. In this case, the DU may use the second QoS parameters for the DRB 2.

In response to receiving the message and/or determination, the DU may send a response message to the CU. The response message may be a context setup response message. The response message may comprise a UE identifier, DRB setup list, DRB failed to setup list. The UE identifier may identify the wireless device during the F1 operations. The UE identifier may be a gNB-CU UE F1AP identifier/identity. The UE identifier may be a gNB-DU UE F1AP identifier/identity. The DRB setup list may comprise one or more DRB identities/identifiers which are successfully accepted to be setup the radio bearer by the DU. The DRB setup list may further comprise the applied QoS parameters for the DRB/session. The DRB setup list may further comprise the fulfilled QoS parameters for the DRB/session. In an example, if the first QoS parameter applied/fulfilled, the DRB setup list may further indicate that the first QoS parameters is applied/fulfilled. If the second QoS parameter applied/fulfilled, the DRB setup list may further indicate that the second QoS parameters is applied/fulfilled. In an example, if the first AMBR applied/fulfilled, the DRB setup list may further indicate that the first AMBR is applied/fulfilled. If the second QoS parameter applied/fulfilled, the DRB setup list may further indicate that the second AMBR is applied/fulfilled.

In an example, the DRB failed to setup list may comprise one or more DRB identities/identifiers which is failed to setup the radio bearers. In an example, the DRB failed to setup list may comprise one or more DRB identities, that is not accepted to setting up the radio bearers by the DU. The DRB failed to setup list may further comprise a cause value for a failure (e.g., not accepted). The cause value for the failure may comprise network energy saving (NES), not enough network energy, control processing overload, not enough user plane processing resources, hardware failure, O&M intervention. In an example, the DU may not accept a DRB X to save network energy. If the DU didn't accept the DRB X to save network energy or there is not enough network energy (e.g., network energy being limited), DU indicate the appropriate cause value (e.g., NES, not enough network energy, network energy being limited) in the DRB failed to setup list. In response to receiving the response message, the CU may continue the session establishment/activation procedure with core network function (e.g., AMF. SMF). The CU may use the cause value for future execution. The CU may indicate the cause value to the core network and core network node use this cause value for future management. In an example, the cause value may indicate NES or “not enough network energy”. The core network node may downgrade the QoS parameters for DRB of a wireless device accessing to the DU.

In an example, the DU may detect of NES applicability and/or NES strategy. In an example, the DU may determine “network energy is not limited” and apply first QoS parameters/first AMBR. The DU may notify to the CU, if the applicable QoS parameter is updated.

In an example, the context setup request message may further comprise a second parameter indicating whether the wireless device is authorized to access to the DU, third information element indicating whether the wireless device is authorized to use the sidelink for vehicle to everything (V2X) service, forth information element indicating whether the wireless device is authorized to use one or more proximity services, fifth information element indicating whether the wireless device is authorized to act network-controlled repeater. sixth information element indicating whether the wireless device is authorized. The parameter may be different from the first parameter and authorization of the third, fourth, fifth and sixth information.

In an example, a distributed unit (DU) of a base station (BS) may receive one or more messages from a central unit (CU) of the BS. The one or more messages comprising one or more parameters indicating whether network energy saving (NES) is authorized for a wireless device. The DU may determine based on the one or more message, whether to apply the NES to one or more cells of the wireless device. In response to the determining, the DU may send to the wireless device, one or more control signals for communication between the wireless device and the DU.

In an example, a distributed unit (DU) of a base station (BS) may receive from a central unit (CU) of the BS, a first message requesting a context setup of a wireless device. The first message may comprise a wireless device identifier assigned by the CU, a parameter indicating whether network energy saving (NES) is authorized/activated for a wireless device. The DU may send to the CU, a second message indicating a successful context setup with the wireless device.

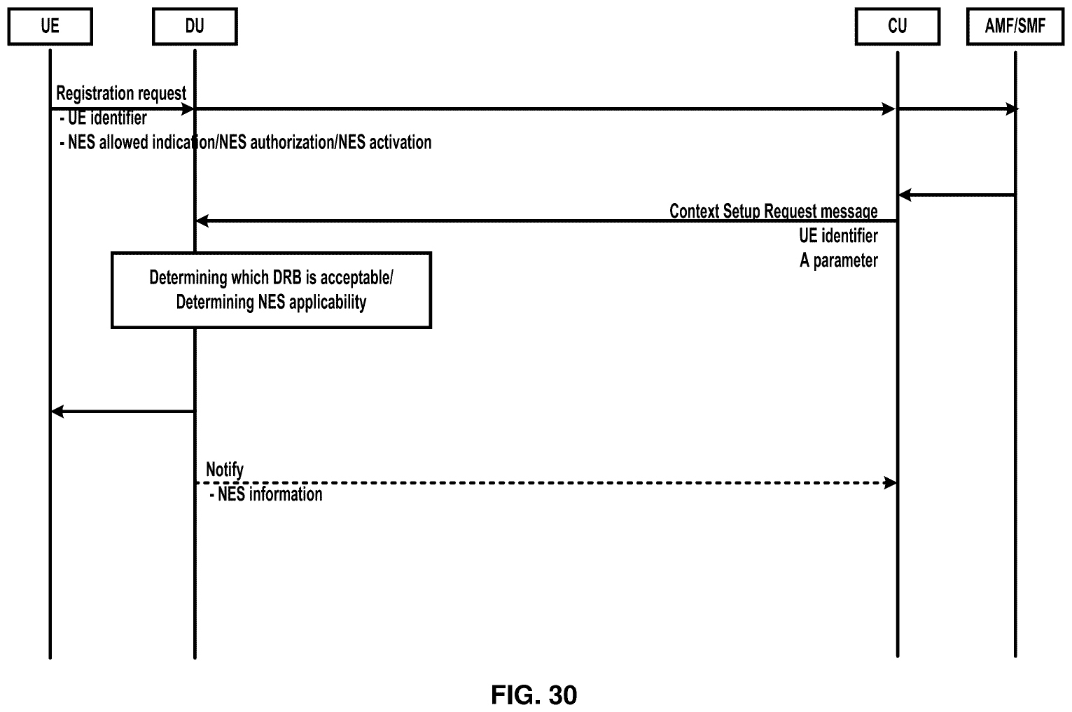

FIG. 30 illustrates an example as per an aspect of an embodiment of the present disclosure. The example embodiment of the FIG. 30 may be used with the example embodiments of FIG. 24, FIG. 25, FIG. 27, FIG. 28 and FIG. 29. Previously explained, the parameter (e.g., the NES is authorized/allowed/activated for a wireless device) may be inherited from the UDM as part of subscription information. As illustrated in FIG. 30, the wireless device may ask to update the parameter (NES authorized/allowed/activated on demand). The wireless device may indicate the parameter or request to update the parameter during the registration procedure (shown in FIG. 18). The registration request message may comprise the second parameter to update the parameter. If the wireless device request to deactivate or do not allow/authorize the NES in the registration request, the AMF may update the information for the NES in the AMF and provide the CU/DU to the update value. In an example, the subscription information may indicate the wireless device is allowed the NES. If the registration request message indicates the NES is not allowed or deactivated, the CU may indicate to the DU that the parameter indicate “the NES is not activated/allowed/authorized for the wireless device”. The updated information (the parameter) by the wireless device, may be used FIG. 24, FIG. 25, FIG. 27, FIG. 28 and FIG. 29.

1. A method comprising:
receiving, by a distributed unit (DU) from a central unit (CU), one or more messages comprising one or more parameters indicating that network energy saving (NES) is authorized for a wireless device.

2. The method of claim 1, further comprising, determining, by the DU and based on the one or more messages, whether to apply the NES to one or more cells of the wireless device.

3. The method of claim 2, based on the determining, sending by the DU to the wireless device, one or more indicators indicating an activation of a cell discontinuous transmission (DTX) of the one or more cells.

4. The method of claim 3, further comprising, receiving, by the DU from the CU, radio resource control (RRC) information of the wireless device, wherein the RRC information comprises one or more radio capabilities of the wireless device at least one of:
cell discontinuous transmission (DTX);
cell discontinuous reception (DRX);
extended idle mode DRX;
cell deactivation;
synchronization signal block deactivation; or
quality of service (QOS) degradation.

5. The method of claim 4, wherein the determining is further based on the RRC information of the wireless device.

6. The method of claim 2, further comprising, sending by the DU to the wireless device, one or more second indicators, indicating an activation of a cell discontinuous reception (DRX) of the one or more cells.

7. The method of claim 2, further comprising:
sending by the DU to the CU, a first message, requesting a F1 setup between the DU and the CU, wherein the first message comprises a second parameter indicating that the NES is capable of the DU; and
receiving, by the DU from the CU, a second message, indicating a successful F1 setup.

8. A distributed unit (DU) comprising one or more processors and memory storing instructions that, when executed by the one or more processors, cause the DU to:
receive, from a central unit (CU), one or more messages comprising one or more parameters indicating that network energy saving (NES) is authorized for a wireless device.

9. The DU of claim 8, wherein the instructions further cause the DU to determine, based on the one or more messages, whether to apply the NES to one or more cells of the wireless device.

10. The DU of claim 9, wherein the instructions further cause the DU to send to the wireless device and based on the determining, one or more indicators indicating an activation of a cell discontinuous transmission (DTX) of the one or more cells.

11. The DU of claim 10, wherein the instructions further cause the DU to receive, from the CU, radio resource control (RRC) information of the wireless device, wherein the RRC information comprises one or more radio capabilities of the wireless device at least one of:
cell discontinuous transmission (DTX);
cell discontinuous reception (DRX);
extended idle mode DRX;
cell deactivation;
synchronization signal block deactivation; or
quality of service (QOS) degradation.

12. The DU of claim 11, wherein the determining is further based on the RRC information of the wireless device.

13. The DU of claim 9, wherein the instructions further cause the DU to send, to the wireless device, one or more second indicators, indicating an activation of a cell discontinuous reception (DRX) of the one or more cells.

14. The DU of claim 9, wherein the instructions further cause the DU to:
send, to the CU, a first message, requesting a F1 setup between the DU and the CU, wherein the first message comprises a second parameter indicating that the NES is capable of the DU; and
receive, from the CU, a second message, indicating a successful F1 setup.

15. A non-transitory computer-readable medium comprising instructions that, when executed by one or more processors of a distributed unit (DU), cause the DU to:
receive, from a central unit (CU), one or more messages comprising one or more parameters indicating that network energy saving (NES) is authorized for a wireless device.

16. The non-transitory computer-readable medium of claim 15, wherein the instructions further cause the DU to determine, based on the one or more messages, whether to apply the NES to one or more cells of the wireless device.

17. The non-transitory computer-readable medium of claim 16, wherein the instructions further cause the DU to send to the wireless device and based on the determining, one or more indicators indicating an activation of a cell discontinuous transmission (DTX) of the one or more cells.

18. The non-transitory computer-readable medium of claim 17, wherein the instructions further cause the DU to receive, from the CU, radio resource control (RRC) information of the wireless device, wherein the RRC information comprises one or more radio capabilities of the wireless device at least one of:
cell discontinuous transmission (DTX);
cell discontinuous reception (DRX);
extended idle mode DRX;
cell deactivation;
synchronization signal block deactivation; or
quality of service (QOS) degradation.

19. The non-transitory computer-readable medium of claim 18, wherein the determining is further based on the RRC information of the wireless device.

20. The non-transitory computer-readable medium of claim 16, wherein the instructions further cause the DU to send, to the wireless device, one or more second indicators, indicating an activation of a cell discontinuous reception (DRX) of the one or more cells.
